(19) United States
(12) Patent Application Publication
(10) Pub. No.: US 2026/0078208 A1
(43) Pub. Date: Mar. 19, 2026

(54) COMPOUND, CURABLE RESIN COMPOSITION AND CURED PRODUCT OF SAME

(71) Applicant: NIPPON KAYAKU KABUSHIKI KAISHA, Tokyo (JP)

(72) Inventors: Takayuki TOHJIMA, Tokyo (JP); Masanori HASHIMOTO, Tokyo (JP)

(73) Assignee: NIPPON KAYAKU KABUSHIKI KAISHA, Tokyo (JP)

(21) Appl. No.: 19/131,746

(22) PCT Filed: Nov. 8, 2023
(86) PCT No.: PCT/JP2023/040220

§ 371 Date: May 21, 2025

(30) Foreign Application Priority Data
Nov. 25, 2022 (JP) 2022-187893

(51) Int. Cl. C08F 212/14; B01J 23/04; C08F 2/06; C08F 232/08

(52) U.S. Cl. CPC C08F 212/18; B01J 23/04; C08F 2/06; C08F 232/08

(57) ABSTRACT

The present invention provides: a compound which exhibits excellent heat resistance and low dielectric characteristics without corroding copper foils; a curable resin composition; and a cured product of this curable resin composition. This compound is obtained by causing a compound represented by formula (1), a compound represented by formula (2-1) and/or a compound represented by formula (2-2) to react with each other; and if a is the number of moles of the compound represented by formula (1), β1 is the number of moles of the compound represented by formula (2-1) and β2 is the number of moles of the compound represented by formula (2-2), (β1+β2)/α is 1.8 to 2.1.

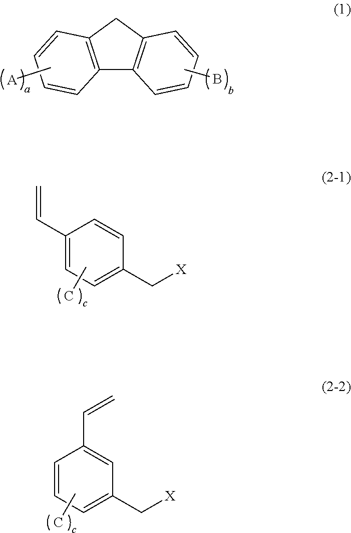

### TECHNICAL FIELD

The present invention relates to a compound having a specific structure, a curable resin composition and a cured product thereof, and is suitable for use in electric and electronic parts such as semiconductor encapsulants, printed wiring boards and build-up laminates, lightweight and high-strength materials such as carbon fiber reinforced plastics and glass fiber reinforced plastics, and 3D printing applications.

### BACKGROUND ART

In recent years, the laminates on which electric and electronic components are mounted have come to be used in a wider range of fields, and the required characteristics have become more extensive and sophisticated. Conventional semiconductor chips were mainly mounted on metal lead frames, but semiconductor chips with high processing power, such as central processing units (hereinafter referred to as CPUs), are increasingly being mounted on laminates made of polymer materials.

The fifth-generation communication system “5G”, which is currently being developed at an accelerated pace, is expected to further increase capacity and speed. In 5G, the frequency used will become higher, but reducing transmission loss is important to achieve high-speed communication using high frequencies, and further low dielectric properties will be required for the board material. The transmission loss occurring on the printed circuit board is due to conductor loss and dielectric loss. As described in Non-Patent Document 1, since the dielectric loss is proportional to the square root of the relative permittivity and the dielectric dissipation factor of the dielectric, it can be said that improving the dielectric dissipation factor, which has a higher contribution rate than the relative permittivity, is effective in reducing transmission loss. Low-dielectric materials include thermoplastic materials such as PTFE (polytetrafluoroethylene) and LCP (liquid crystal polymer). They are poor in moldability compared to thermosetting resins. In light of this, the development of thermosetting resins with excellent low dielectric properties is desired.

In addition, in recent years, the wiring used in semiconductor packages has been switched from gold wires to copper wires. Copper wires have many advantages over gold wires, such as low cost, high electrical conductivity, and high thermal conductivity, but are more susceptible to oxidation than gold wires, and are said to have inferior package reliability. It has been reported that the reliability of semiconductor packages is affected by free chlorine ions and pH in the resin, and the influence of halogen elements bonded to the skeleton of organic matter such as hydrolysis-derived chlorine cannot be denied (Non-Patent Document 2). In view of the above, a resin material that does not cause corrosion of copper wiring is required to realize a highly reliable semiconductor package.

In light of this background, polymeric materials with high reliability (copper wiring does not corrode, etc.) and low dielectric properties have been studied. For example, Patent Document 1 proposes a thermosetting resin composition containing a maleimide resin and a phenol aralkyl resin having a group containing an aliphatic unsaturated bond such as a propenyl group. However, on the other hand, since phenolic hydroxy groups that do not participate in the reaction remain during the curing reaction, the electrical properties are not sufficient. Patent Document 2 also discloses an allyl ether modified resin in which phenolic hydroxy groups are allyl etherified. However, it has been shown that Claisen rearrangement occurs at 190° C., and since phenolic hydroxy groups that do not contribute to the curing reaction are generated at 200° C., which is the molding temperature of a general substrate, the electrical properties are not satisfactory.

### CITATION LIST

### Non-Patent Literature

Non-Patent Literature 1: “Consideration of signal loss factor in the high-speed Signal transmission on a printed Circuit board”, 29th Spring Conference of the Japan Institute of Electronics Packaging, Session ID: 16P1-17, 2015
Non-Patent Literature 2: “Effect of the Ion exchanger “IXER”, “IXEPLAS®” for the reliability of the copper wiring packages,” Toagosei Group Annual Research Report TREND 2016, Vol. 19

### PATENT LITERATURE

Patent Literature 1: Japanese Patent Application Publication No. H04-359911A
Patent Literature 2: International Publication No. 2016/002704

### SUMMARY OF THE INVENTION

### Technical Problem

The present invention has been made in consideration of the above circumstances, and an object of the present invention is to provide a compound, a curable resin composition, and a cured product thereof that have excellent heat resistance and low dielectric properties without corroding copper foil.

### Solution to Problem

That is, the present invention relates to the following [1] to [9]. In the present application, “(Numerical value 1) to (Numerical value 2)” indicates that the upper and lower limits are included.

[1]

A compound obtained by reacting a compound represented by the following formula (1) with a compound represented by the following formula (2-1) and/or a compound represented by the following formula (2-2), in which (β1+β2)/α is 1.8 or more and 2.1 or less, where a is the number of moles of the compound represented by the formula (1), β1 is the number of moles of the compound represented by the formula (2-1), and β2 is the number of moles of the compound represented by the formula (2-2).

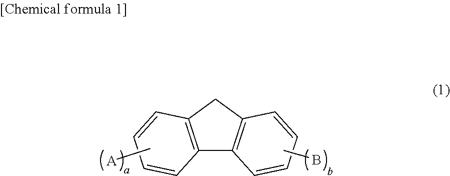

(In the above formula (1), A and B each represent a hydrogen atom or a hydrocarbon group having 1 to 5 carbon atoms, and a and b each represent an integer of 1 to 4.)

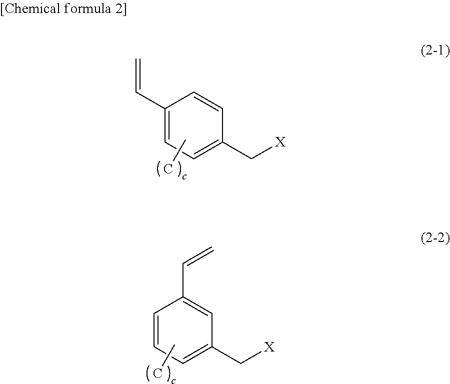

(In the above formula (2-1), C represents a hydrogen atom or a hydrocarbon group having 1 to 5 carbon atoms, X represents a halogen element, and c represents an integer of 1 to 4. In the above formula (2-2), C represents a hydrogen atom or a hydrocarbon group having 1 to 5 carbon atoms, X represents a halogen element, and c represents an integer of 1 to 4.)
[2]

The compound according to the above item [1], in which (β1+β2)/α is 1.8 or more and 1.95 or less.

[3]

The compound according to the above item [1] or [2], which is for use in a printed wiring board.

[4]

The compound according to any one of the above items [1] to [3], in which a dielectric dissipation factor at a frequency of 10 GHz measured at 25° C. is 0.0016 or less.

[5]

The compound according to any one of the above items [1] to [4], in which β1/β2 is 0.5 to 25.

[6]

The compound according to any one of the above items [1] to [4], in which β1/β2 is 0.8 to 3.0.

[7]

A curable resin composition containing the compound according to any one of the preceding items [1] to [6].

[8]

A cured product obtained by curing the compound according to any one of the preceding items [1] to [6] or the curable resin composition according to the preceding item [7].

[9]

A method for producing a compound represented by the following formula (3), which is obtained by reacting a compound represented by the following formula (1) with a compound represented by the following formula (2-1) and/or a compound represented by the formula (2-2) in an aprotic polar solvent in the presence of a basic catalyst.

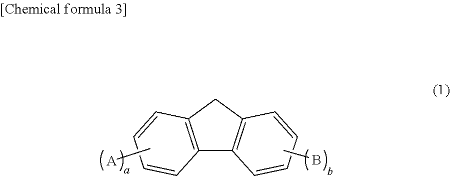

(In the above formula (1), A and B each represent a hydrogen atom or a hydrocarbon group having 1 to 5 carbon atoms, and a and b each represent an integer of 1 to 4.)

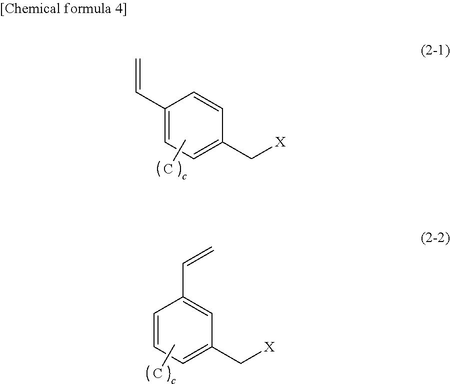

(In the above formula (2-1), C represents a hydrogen atom or a hydrocarbon group having 1 to 5 carbon atoms, X represents a halogen element, and c represents an integer of 1 to 4. In the above formula (2-2), C represents a hydrogen atom or a hydrocarbon group having 1 to 5 carbon atoms, X represents a halogen element, and c represents an integer of 1 to 4.)

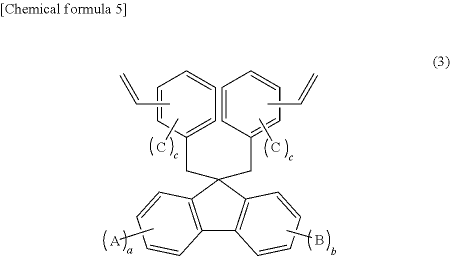

(In the above formula (3), A, B, a and b represent A, B, a and b in the above formula (1), and C and c represent C and c in the above formula (2-1) or the above formula (2-2).)

### Advantageous Effects of Invention

The compound and the curable resin composition of the present invention do not corrode copper foil and have excellent heat resistance and low dielectric properties.

### BRIEF DESCRIPTION OF DRAWINGS

FIG. 1 shows an HP-LC chart of Example 1.

FIG. 2 shows an HP-LC chart of Example 2.

FIG. 3 shows an HP-LC chart of Example 3.

FIG. 4 shows an HP-LC chart of Example 4.

FIG. 5 shows an HP-LC chart of Example 5.

FIG. 6 shows an HP-LC chart of Example 6.

FIG. 7 shows an HP-LC chart of Example 7.

### DESCRIPTION OF EMBODIMENTS

The compound of the present invention can be obtained by reacting a compound represented by the following formula (1) with a compound represented by the following formula (2-1) and/or a compound represented by the following formula (2-2).

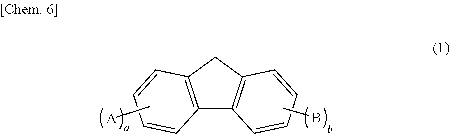

In the above formula (1), A and B each represent a hydrogen atom or a hydrocarbon group having 1 to 5 carbon atoms, preferably a hydrogen atom or a hydrocarbon group having 1 to 3 carbon atoms, and more preferably a hydrogen atom. If the number of carbon atoms is 5 or less, the molecular vibration is unlikely to occur when exposed to high frequency waves, and the electrical properties are excellent. Furthermore, if it is a hydrogen atom, it is possible to suppress the deterioration of the dielectric properties and water absorption properties associated with the generation of polar groups resulting from the oxidation reaction of the alkyl group during high temperature storage tests. Each of a and b represents an integer of 1 to 4, and is preferably 1.

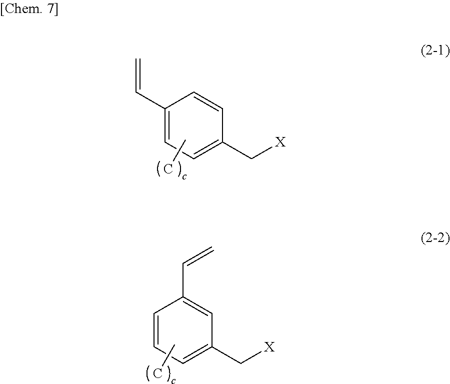

In the above formulas (2-1) and (2-2), C represents a hydrogen atom or a hydrocarbon group having 1 to 5 carbon atoms, preferably a hydrogen atom or a hydrocarbon group having 1 to 3 carbon atoms, and more preferably a hydrogen atom. If C has 5 or less carbon atoms, the molecular vibration is unlikely to occur when exposed to high frequency waves, and therefore the electrical properties are excellent. In addition, if C represents a hydrogen atom, it is possible to suppress the deterioration of the dielectric properties and water absorption properties associated with the generation of polar groups resulting from the oxidation reaction of the alkyl group during the high temperature storage test. X represents a halogen element, and from the viewpoint of reactivity and suppression of waste generation, X is preferably a bromine atom or a chlorine atom, and more preferably a chlorine atom. c represents an integer of 1 to 4, preferably c is 1.

The compound obtained by reacting the compound represented by the formula (1) with the compound represented by the formula (2-1) and/or the compound represented by the formula (2-2) is represented by the following formula (3).

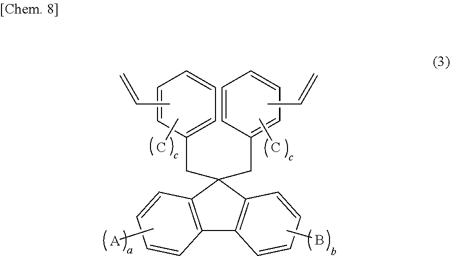

The values of A, B, C, a, b, and c in the above formula (3) and their preferred ranges are the same as those in the above formulas (1), (2-1), and (2-2).

The compound of the present invention has low dielectric properties. Specifically, the dielectric dissipation factor at a frequency of 10 GHz at 25° C., measured by the method described in the Examples below, is preferably 0.0016 or less, more preferably 0.0012 or less. These values are required by the market, and correspond to, for example, the values of MEGTRON (registered trademark) 8 manufactured by Panasonic Corporation (see Panasonic Holdings Co., Ltd. press release dated Jan. 18, 2022, “Development of ‘MEGTRON 8’, a low transmission loss multilayer circuit board material for high-speed communication network equipment”).

In the compound of the present invention, when the number of moles of the compound represented by the formula (1) is a, the number of moles of the compound represented by the formula (2-1) is β1, and the number of moles of the compound represented by the formula (2-2) is β2, (β1+β2)/α is preferably 1.8 or more and 2.1 or less, more preferably 1.8 or more and 2.0 or less, and particularly preferably 1.8 or more and 1.95 or less. When (β1+β2)/α is less than 1.8, the compound represented by the formula (1) remains unreacted, so that the toughness of the cured film may decrease and the dielectric properties may deteriorate. This is because the unreacted compound represented by the formula (1) does not have a structure that can be crosslinked, and the methylene structure at the 9th position of the compound represented by the formula (1) reacts with oxygen to generate a ketone, which increases the polarity. If (β1+β2)/α is greater than 2.1, the halogen element of the compound represented by formula (2) that has not been completely removed by purification may be eliminated during curing (for example, at a temperature of 175° C. or higher) or during a high-temperature, high-humidity test (85° C., 85% humidity, 120° C., 100% humidity, etc.), which may lead to corrosion of the copper wiring. The amount of residual halogen contained in the compound of the present invention is preferably 1 to 10,000 ppm, more preferably 1 to 3,000 ppm, and even more preferably 1 to 2,000 ppm.

In addition, when both the compound represented by the formula (2-1) and the compound represented by the formula (2-2) are used, β1/β2 is preferably 0.5 to 25, more preferably 0.8 to 3.0, and particularly preferably 0.9 to 1.1. If β1/β2 is 25 or less, the crystallinity of the compound is low, and the solvent solubility is good. The closer to 1, the better the solvent solubility is. On the other hand, if β1/β2 is 0.5 or more, this is due to an increase in the compound represented by the formula (2-1), and the steric hindrance is reduced, resulting in good reactivity and good curability.

The method for producing the compound of the present invention is not particularly limited, but the compound of the present invention can be derived from the compound represented by the formula (1) and the compound represented by the formula (2-1) and/or the compound represented by the formula (2-2).

Specifically, the compound of the present invention can be obtained by reacting the compound represented by the formula (1) with the compound represented by the formula (2-1) and/or the compound represented by the formula (2-2) in an aprotic polar solvent in the presence of a basic catalyst. Examples of the aprotic polar solvent include dimethyl sulfone, dimethyl sulfoxide, dimethylformamide, dimethylacetamide, 1,3-dimethyl-2-imidazolidinone, and N-methylpyrrolidone, and two or more of them may be used in combination. In addition, a non-water-soluble solvent may be used in combination as necessary. Examples of the non-water-soluble solvent include, but are not limited to, aromatic solvents such as toluene and xylene, aliphatic solvents such as cyclohexane and n-hexane, ether-based solvents such as diethyl ether and diisopropyl ether, ester-based solvents such as ethyl acetate and butyl acetate, and ketone-based solvents such as methyl isobutyl ketone and cyclopentanone. Two or more of these may be used in combination. The catalyst is not particularly limited, but examples include basic catalysts such as sodium hydroxide, potassium hydroxide, and potassium carbonate. The order of charging the compound represented by formula (1), the compound represented by formula (2-1) and/or the compound represented by formula (2-2), and the base can be changed as necessary, but a method in which the compound represented by formula (1), an aprotic polar solvent, and a base are added, the compound represented by formula (1) is sufficiently ionized, and then the compound represented by formula (2-1) and/or the compound represented by formula (2-2) is added is preferred. When the reaction is carried out without using an aprotic polar solvent, the reaction rate is significantly reduced. When an aprotic polar solvent is not used, the reaction is generally carried out using a phase transfer catalyst. In this case, the raw material is dissolved in a non-aqueous solvent such as toluene, and the compound represented by the formula (1), the compound represented by the formula (2-1) and/or the compound represented by the formula (2-2) are reacted in the presence of a base catalyst such as an aqueous sodium hydroxide solution and a phase transfer catalyst such as tetrabutylammonium bromide. In this case, it is difficult to completely remove the phase transfer catalyst such as tetrabutylammonium bromide, making it difficult to achieve low dielectric properties (low permittivity and low dielectric dissipation factor), and the remaining phase transfer catalyst may cause problems such as ion migration when a substrate material using the compound of the present invention is subjected to a long-term wet heat reliability test or the like. The reaction temperature is preferably 0 to 100° C., more preferably 0 to 80° C., and even more preferably 0 to 60° C. At a temperature exceeding the upper limit, the compound of the present invention may self-polymerize and gel. At a temperature below the lower limit, the reaction may not proceed sufficiently. As a post-treatment after the reaction, neutralization may be performed with any acid compound. In addition, an alcohol compound, water, or the like may be added to the reaction solution as necessary to recover the target product as crystals. The obtained reaction solution or crystals may be redissolved in any solvent and subjected to an extraction step. For the extraction step, an aromatic hydrocarbon solvent such as toluene or xylene may be used alone or in combination with a non-aromatic hydrocarbon such as cyclohexane. After extraction, the organic layer is washed with water until the wastewater becomes neutral, and the solvent is removed using an evaporator or the like to obtain the target compound.

The compound of the present invention can be cured by itself by heating or the like, but performance can also be improved by adding various materials to form a curable resin composition.

### [Curing Accelerator]

The curing property of the curable resin composition of the present invention can be improved by adding a curing accelerator. As the curing accelerator, an anionic curing accelerator that accelerates the curing reaction by generating anions upon irradiation with ultraviolet light or visible light or heating, or a cationic curing accelerator that accelerates the curing reaction by generating cations upon irradiation with ultraviolet light or visible light or heating, is preferred.

Examples of the anionic curing accelerator include imidazoles such as 2-methylimidazole, 2-ethylimidazole, and 2-ethyl-4-methylimidazole, trialkylamines such as triethylamine and tributylamine, 4-dimethylaminopyridine, benzyldimethylamine, 2,4,6,-tris(dimethylaminomethyl)phenol, and 1,8-diazabicyclo(5,4,0)-undecene, with 4-dimethylaminopyridine and 1,8-diazabicyclo(5,4,0)-undecene being preferred. Other examples include phosphines such as triphenylphosphine, quaternary ammonium salts such as tetrabutylammonium salts, triisopropylmethylammonium salts, trimethyldecanylammonium salts, cetyltrimethylammonium salts, and hexadecyltrimethylammonium hydroxide, but are not limited thereto. These may be used alone or in combination.

Examples of the cationic curing accelerator include quaternary phosphonium salts such as triphenylbenzylphosphonium salt, triphenylethylphosphonium salt, and tetrabutylphosphonium salt (the counter ion of the quaternary salt may be a halogen, an organic acid ion, a hydroxide ion, or the like, and is not particularly specified, but an organic acid ion or a hydroxide ion is particularly preferred); transition metal compounds (transition metal salts) such as tin octylate, zinc carboxylate (zinc 2-ethylhexanoate, zinc stearate, zinc behenate, zinc myristate), and zinc phosphate (zinc octylphosphate, zinc stearylphosphate), but are not limited thereto. Furthermore, these may be used alone or in combination.

The curing accelerator is used in an amount of 0.01 to 5.0 parts by mass based on 100 parts by mass of the curable resin composition, as required.

### [Inorganic Filler]

The curable resin composition of the present invention may contain an inorganic filler. Examples of inorganic fillers include powders such as fused silica, crystalline silica, porous silica, alumina, zircon, calcium silicate, calcium carbonate, quartz powder, silicon carbide, silicon nitride, boron nitride, zirconia, aluminum nitride, graphite, forsterite, steatite, spinel, mullite, titania, talc, clay, iron oxide asbestos, and glass powder, and inorganic fillers obtained by making these into a spherical or crushed shape, but are not limited thereto. In addition, these may be used alone or in combination.

When a curable resin composition for semiconductor encapsulation is obtained, the amount of the inorganic filler used is preferably 80 to 92 parts by mass, and more preferably 83 to 90 parts by mass, based on 100 parts by mass of the curable resin composition. When a curable resin composition for interlayer insulating layer forming materials, copper-clad laminates, prepregs, RCCs, and other substrate materials is obtained, the amount of the inorganic filler used is preferably 5 to 80 parts by mass, and more preferably 10 to 60 parts by mass, based on 100 parts by mass of the curable resin composition.

### [Polymerization Initiator]

The curable resin composition of the present invention can also improve the curability by adding a polymerization initiator. The polymerization initiator is a compound capable of polymerizing an olefin functional group such as an ethylenically unsaturated bond, and examples of the polymerization initiator include an olefin metathesis polymerization initiator, an anionic polymerization initiator, a cationic polymerization initiator, and a radical polymerization initiator. Among these, it is preferable to use a radical polymerization initiator having curability and moderate stability. The radical polymerization initiator is a compound that generates radicals by irradiation with ultraviolet light or visible light or by heating, and initiates a chain polymerization reaction. Examples of radical polymerization initiators that can be used include organic peroxides, azo compounds, and benzopinacoles, and it is preferable to use an organic peroxide because it has little effect on curing temperature control, outgassing suppression, and electrical properties of decomposition products.

Examples of the organic peroxides include: ketone peroxides such as methyl ethyl ketone peroxide and acetylacetone peroxide; diacyl peroxides such as benzoyl peroxide; dialkyl peroxides such as dicumyl peroxide and 1,3-bis-(t-butylperoxyisopropyl)-benzene; peroxyketals such as t-butylperoxybenzoate and 1,1-di-t-butylperoxycyclohexane; alkyl peresters such as α-cumylperoxyneodecanoate, t-butylperoxyneodecanoate, t-butylperoxypivalate, 1,1,3,3-tetramethylbutylperoxy-2-ethylhexanoate, t-amylperoxy-2-ethylhexanoate, t-butylperoxy-2-ethylhexanoate, t-amylperoxy-3,5,5-trimethylhexanoate, t-butylperoxy-3,5,5-trimethylhexanoate, and t-amylperoxybenzoate; peroxycarbonates such as di-2-ethylhexyl peroxydicarbonate, bis(4-t-butylcyclohexyl) peroxydicarbonate, t-butylperoxyisopropyl carbonate, 1,6-bis(t-butylperoxycarbonyloxy)hexane; and t-butyl hydroperoxide, cumene hydroperoxide, t-butyl peroxyoctoate, and lauroyl peroxide, etc. These may be used alone or in combination. Among the above organic peroxides, ketone peroxides, diacyl peroxides, hydroperoxides, dialkyl peroxides, peroxyketals, alkyl peresters, percarbonates, etc. are preferred, and dialkyl peroxides are more preferred.

Examples of the azo-based compound include, but are not limited to, azobisisobutyronitrile, 4,4′-azobis(4-cyanovaleric acid), 2,2′-azobis(2,4-dimethylvaleronitrile), etc. These may be used alone or in combination.

The amount of the polymerization initiator added is preferably 0.01 to 5 parts by mass, particularly preferably 0.01 to 3 parts by mass, per 100 parts by mass of the curable resin composition. If the amount of the polymerization initiator used is less than 0.01 part by mass, the molecular weight may not be sufficiently extended during the polymerization reaction, and if it is more than 5 parts by mass, the dielectric properties such as the permittivity and dielectric dissipation factor may be impaired.

### [Polymerization Inhibitor]

The curable resin composition of the present invention may contain a polymerization inhibitor. By containing a polymerization inhibitor, storage stability is improved and the reaction initiation temperature can be controlled. By controlling the reaction initiation temperature, it becomes easy to ensure fluidity, impregnation into glass cloth and the like is not impaired, and B-stage such as prepreg formation is facilitated. If the polymerization reaction proceeds too much during prepreg formation, problems such as difficulty in lamination during the lamination process are likely to occur.

The polymerization inhibitor may be added during or after the synthesis of the compound of the present invention. The amount of the polymerization inhibitor used is 0.008 to 2 parts by weight, preferably 0.01 to 1 part by weight, based on 100 parts by weight of the compound of the present invention.

Examples of the polymerization inhibitor include phenol-based, sulfur-based, phosphorus-based, hindered amine-based, nitroso-based, and nitroxyl radical-based polymerization inhibitors. The polymerization inhibitor may be used alone or in combination. Among these, in the present invention, phenol-based, hindered amine-based, nitroso-based, and nitroxyl radical-based polymerization inhibitors are preferred.

Examples of the phenol-based polymerization inhibitor include: monophenols such as 2,6-di-t-butyl-p-cresol, butylated hydroxyanisole, 2,6-di-t-butyl-p-ethylphenol, stearyl-β-(3,5-di-t-butyl-4-hydroxyphenyl)propionate, isooctyl-3-(3,5-di-t-butyl-4-hydroxyphenyl)propionate, 2,4-bis-(n-octylthio)-6-(4-hydroxy-3,5-di-t-butylanilino)-1,3,5-triazine, and 2,4-bis[(octylthio)methyl]-o-cresol; bisphenols such as 2,2′-methylenebis(4-methyl-6-t-butylphenol), 2,2′-methylenebis(4-ethyl-6-t-butylphenol), 4,4′-thiobis(3-methyl-6-t-butylphenol), 4,4′-butylidenebis(3-methyl-6-t-butylphenol), triethylene glycol-bis[3-(3-t-butyl-5-methyl-4-hydroxyphenyl)propionate], 1,6-hexanediol-bis[3-(3,5-di-t-butyl-4-hydroxyphenyl)propionate], N,N′-hexamethylenebis(3,5-di-t-butyl-4-hydroxy-hydrocinnamamide), 2,2-thio-diethylenebis[3-(3,5-di-t-butyl-4-hydroxyphenyl)propionate], 3,5-di-t-butyl-4-hydroxy benzylphosphonate-diethyl ester, 3,9-bis[1,1-dimethyl-2-{B-(3-t-butyl-4-hydroxy-5-methylphenyl)propionyloxy}ethyl]2,4,8,10-tetraoxaspiro[5,5]undecane, bis(3,5-di-t-butyl-4-hydroxybenzylsulfonate ethyl) calcium; polymeric phenols such as 1,1,3-tris(2-methyl-4-hydroxy-5-t-butylphenyl) butane, 1,3,5-trimethyl-2,4,6-tris(3,5-di-t-butyl-4-hydroxy bynzyl)benzene, tetrakis-[methylene-3-(3′,5′-di-t-butyl-4′-hydroxyphenyl)propionate]methane, bis[3,3′-bis-(4′-hydroxy-3′-t-butylphenyl) butyric acid]glycol ester, tris-(3,5-di-t-butyl-4-hydroxybenzyl)-isocyanurate, 1,3,5-tris(3′,5′-di-t-butyl-4′-hydroxy benzyl)-S-triazine-2,4,6-(1H,3H,5H)trione, tocopherol and other polymeric phenols, but are not limited thereto.

Examples of the sulfur-based polymerization inhibitor include, but are not limited to, dilauryl-3,3′-thiodipropionate, dimyristyl-3,3′-thiodipropionate, and distearyl-3,3′-thiodipropionate.

Examples of the phosphorus-based polymerization inhibitor include: phosphites such as triphenyl phosphite, diphenyl isodecyl phosphite, phenyl diisodecyl phosphite, tris(nonylphenyl)phosphite, diisodecyl pentaerythritol phosphite, tris(2,4-di-t-butylphenyl)phosphite, cyclic neopentane tetrayl bis(octadecyl)phosphite, cyclic neopentane tetrayl bis(2,4-di-t-butylphenyl)phosphite, cyclic neopentane tetrayl bis(2,4-di-t-butyl-4-methylphenyl)phosphite, bis[2-t-butyl-6-methyl-4-{2-(octadecyloxy carbonyl)ethyl}phenyl]hydrogen phosphite; and oxaphosphaphenanthrene oxides such as 9,10-dihydro-9-oxa-10-phosphaphenanthrene-10-oxide, 10-(3,5-di-t-butyl-4-hydroxybenzyl)-9,10-dihydro-9-oxa-10-phosphaphenanthrene-10-oxide, 10-decyloxy-9,10-dihydro-9-oxa-10-phosphaphenanthrene-10-oxide, but are not limited to these.

Examples of the hindered amine-based polymerization inhibitor include, but are not limited to: ADK STAB LA-40MP, ADK STAB LA-40Si, ADK STAB LA-402AF, ADK STAB LA-87, ADK STAB LA-82, ADK STAB LA-81, ADK STAB LA-77Y, ADK STAB LA-77G, ADK STAB LA-72, ADK STAB LA-68, ADK STAB LA-63P, ADK STAB LA-57, and ADK STAB LA-52 (manufactured by ADEK Corporation); Chimassorb 2020FDL, Chimassorb 944FDL, Chimassorb 944LD, Tinuvin 622SF, Tinuvin PA144, Tinuvin 765, Tinuvin 770DF, Tinuvin XT55FB, Tinuvin 111FDL, Tinuvin 783FDL, and Tinuvin 791FB (manufactured by BASF Japan Ltd.).

Examples of the nitroso-based polymerization inhibitor include, but are not limited to, p-nitrosophenol, N-nitrosodiphenylamine, and the ammonium salt of N-nitrosophenylhydroxyamine (cupferron), etc. Among these, the ammonium salt of N-nitrosophenylhydroxyamine (cupferron) is preferred.

Examples of the nitroxyl radical polymerization inhibitor include di-tert-butyl nitroxide, 2,2,6,6-tetramethylpiperidine-1-oxyl, 4-hydroxy-2,2,6,6-tetramethylpiperidine-1-oxyl, 4-oxo-2,2,6,6-tetramethylpiperidine-1-oxyl, 4-amino-2,2,6,6-tetramethylpiperidine-1-oxyl, 4-methoxy-2,2,6,6-tetramethylpiperidine-1-oxyl, 4-acetoxy-2,2,6,6-tetramethylpiperidine-1-oxyl, 4-benzoyloxy-2,2,6,6-tetramethylpiperidine-1-oxyl, and the like, but are not limited thereto.

### [Flame Retardant]

The curable resin composition of the present invention may contain a flame retardant. Examples of the flame retardant include halogen-based flame retardants, inorganic flame retardants (antimony compounds, metal hydroxides, nitrogen compounds, boron compounds, etc.), and phosphorus-based flame retardants. From the viewpoint of achieving halogen-free flame retardancy, phosphorus-based flame retardants are preferred.

The phosphorus-based flame retardant may be either a reactive type or an additive type. Specific examples include: phosphoric acid esters such as trimethyl phosphate, triethyl phosphate, tricresyl phosphate, trixylyleneyl phosphate, cresyl diphenyl phosphate, cresyl-2,6-dixylyleneyl phosphate, 1,3-phenylene bis(dixylyleneyl phosphate), 1,4-phenylene bis(dixylyleneyl phosphate), and 4,4′-biphenyl(dixylyleneyl phosphate): phosphanes such as 9,10-dihydro-9-oxa-10-phosphaphenanthrene-10-oxide and 10 (2,5-dihydroxyphenyl)-10H-9-oxa-10-phosphaphenanthrene-10-oxide; as well as phosphorus-containing epoxy compounds obtained by reacting an epoxy resin with the active hydrogen of the phosphanes, red phosphorus, and the like, but are not limited thereto. These may be used alone or in combination. Among the above-mentioned exemplified substances, phosphates, phosphanes, or phosphorus-containing epoxy compounds are preferred, and 1,3-phenylenebis(dixylylenyl phosphate), 1,4-phenylenebis(dixylylenyl phosphate), 4,4′-biphenyl(dixylylenyl phosphate), or phosphorus-containing epoxy compounds are particularly preferred.

The content of the flame retardant is preferably in the range of 0.1 to 10 parts by mass in 100 parts by mass of the curable resin composition. If it is less than 0.1 part by mass, the flame retardancy may be insufficient, and if it is more than 10 parts by mass, it may have an adverse effect on the moisture absorption and dielectric properties of the cured product.

### [Light Stabilizer]

The curable resin composition of the present invention may contain a light stabilizer. As the light stabilizer, a hindered amine light stabilizer (HALS) or the like is preferable. Examples of HALS include: reaction products of dibutylamine, 1,3,5-triazine, N,N′-bis(2,2,6,6-tetramethyl-4-piperidyl-1,6-hexamethylenediamine and N-(2,2,6,6-tetramethyl-4-piperidyl)butylamine; reaction products of dimethyl succinate and 1-(2-hydroxyethyl)-4-hydroxy-2,2,6,6-tetramethylpiperidine; poly[{6-(1,1,3,3-tetramethylbutyl)amino-1,3,5-triazine-2,4-diyl}{(2,2,6,6-tetramethyl-4-piperidyl)imino}hexamethylene {(2,2,6,6-tetramethyl-4-piperidyl)imino}], bis(1,2,2,6,6-pentamethyl-4-piperidyl)[[3,5-bis(1,1-dimethylethyl)-4-hydroxyphenyl]methyl]butyl malonate, bis(2,2,6,6-tetramethyl-4-piperidyl)sebacate, bis(1,2,2,6,6-pentamethyl-4-piperidyl)sebacate, bis(1-octyloxy-2,2,6,6-tetramethyl-4-piperidyl)sebacate, 2-(3,5-di-t-butyl-4-hydroxybenzyl)-2-n-butylmalonate bis(1,2,2,6,6-pentamethyl-4-piperidyl), and the like, but are not limited thereto. These may be used alone or in combination.

The content of the light stabilizer is preferably in the range of 0.001 to 0.1 parts by mass in 100 parts by mass of the curable resin composition. If the content is less than 0.001 part by mass, the light stabilizing effect may be insufficient, and if the content is more than 0.1 part by mass, the moisture absorption and dielectric properties of the cured product may be adversely affected.

### [Binder Resin]

The curable resin composition of the present invention may use a binder resin. Examples of the binder resin include, but are not limited to, butyral resins, acetal resins, acrylic resins, epoxy-nylon resins, NBR-phenol resins, epoxy-NBR resins, and silicone resins. These may be used alone or in combination.

The amount of the binder resin is preferably within a range that does not impair the flame retardancy and heat resistance of the cured product, and is preferably 0.05 to 50 parts by mass, and more preferably 0.05 to 20 parts by mass, per 100 parts by mass of the curable resin composition, as needed.

### [Additives]

The curable resin composition of the present invention may contain additives. Examples of additives include: modified acrylonitrile copolymers, polyethylene, fluororesins, silicone gels, silicone oils, surface treatment agents for fillers such as silane coupling agents, release agents, and colorants such as carbon black, phthalocyanine blue, and phthalocyanine green.

The amount of the additive is preferably 1 part by mass or less, and more preferably 0.7 parts by mass or less, per 100 parts by mass of the curable resin composition.

The curable resin composition of the present invention may further include epoxy resins, active ester compounds, phenolic resins, polyphenylene ether compounds, amine resins, compounds having ethylenically unsaturated bonds, isocyanate resins, polyamide resins, maleimide compounds, cyanate ester resins, polyimide resins, polybutadiene and modified products thereof, polystyrene and modified products thereof, polyethylene and modified products thereof, etc., which may be used alone or in combination. Of these compounds, it is preferable to contain polyphenylene ether compounds, compounds having ethylenically unsaturated bonds, cyanate ester resins, polybutadiene and modified products thereof, and polystyrene and modified products thereof, from the perspective of the balance of heat resistance, adhesion, and dielectric properties. By containing these compounds, the brittleness of the cured product and adhesion to metals can be improved, and cracks in the package during solder reflow and during reliability tests such as thermal cycles can be suppressed. The total amount of these compounds used is preferably 10 times by mass or less, more preferably 5 times by mass or less, and particularly preferably 3 times by mass or less, relative to the compound of the present invention, unless otherwise specified. The lower limit is preferably 0.1 times by mass or more, more preferably 0.25 times by mass or more, and even more preferably 0.5 times by mass or more. By being within the above range, the effect of the low dielectric property of the compound of the present invention can be utilized while the effect of each compound added can be added. As these components, the following examples can be used.

### [Epoxy Resin]

Preferred examples of the epoxy resin are shown below, but are not limited to these. The epoxy resin may be liquid or solid, and may be used alone or in combination.

Examples of liquid epoxy resins include bisphenol A type epoxy resins, bisphenol F type epoxy resins, bisphenol AF type epoxy resins, naphthalene type epoxy resins, glycidyl ester type epoxy resins, glycidyl amine type epoxy resins, phenol novolac type epoxy resins, alicyclic epoxy resins having an ester skeleton, cyclohexane type epoxy resins, cyclohexane dimethanol type epoxy resins, glycidyl amine type epoxy resins, and epoxy resins having a butadiene structure. Specific examples include “RE310S”, “RE410S” (all manufactured by Nippon Kayaku Co., Ltd., bisphenol A type epoxy resin), “RE303S”, “RE304S”, “RE403S”, “RE404S” (all manufactured by Nippon Kayaku Co., Ltd., bisphenol F type epoxy resin), “HP4032”, “HP4032D”, “HP4032SS” (all manufactured by DIC Corporation, naphthalene type epoxy resin), “828US”, “jER828EL”, “825”, “828EL” (all manufactured by Mitsubishi Chemical Corporation, bisphenol A type epoxy resin), “jE807”, “1750” (all manufactured by Mitsubishi Chemical Corporation, bisphenol F type epoxy resin), “jER152” (manufactured by Mitsubishi Chemical Corporation, phenol Novolac type epoxy resin), “630”, “630LSD” (all manufactured by Mitsubishi Chemical Corporation, glycidylamine type epoxy resin), “ZX1059” (manufactured by Nippon Steel & Sumitomo Metal Chemical Co., Ltd., a mixture of bisphenol A type epoxy resin and bisphenol F type epoxy resin), “EX-721” (manufactured by Nagase ChemteX Corporation, glycidyl ester type epoxy resin), “Celloxide 2021P” (manufactured by Daicel Corporation, alicyclic epoxy resin having an ester skeleton), “PB-3600” (manufactured by Daicel Corporation, epoxy resin having a butadiene structure), “ZX1658”, “ZX1658GS” (all manufactured by Nippon Steel & Sumitomo Metal Chemical Co., Ltd., liquid 1,4-glycidylcyclohexane type epoxy resin), and the like. These may be used alone or in combination of two or more.

Examples of solid epoxy resins include bixylenol type epoxy resins, naphthalene type epoxy resins, naphthalene type tetrafunctional epoxy resins, cresol novolac type epoxy resins, dicyclopentadiene type epoxy resins, trisphenol type epoxy resins, naphthol type epoxy resins, biphenyl type epoxy resins, naphthylene ether type epoxy resins, anthracene type epoxy resins, bisphenol A type epoxy resins, bisphenol AF type epoxy resins, and tetraphenylethane type epoxy resins; and naphthol type epoxy resins, bisphenol AF type epoxy resins, naphthalene type epoxy resins, and biphenyl type epoxy resins are preferable. Specific examples include “HP4032H” (manufactured by DIC Corporation, naphthalene type epoxy resin), “HP-4700”, and “HP-4710” (all manufactured by DIC Corporation, naphthalene type tetrafunctional epoxy resin), “N-690” (manufactured by DIC Corporation, cresol novolac type epoxy resin), “N-695” (manufactured by DIC Corporation, cresol novolac type epoxy resin), “HP-7200”, “HP-7200HH”, and “HP-7200H” (all manufactured by DIC Corporation, dicyclopentadiene type epoxy resin), epoxy resin), “EXA-7311”, “EXA-7311-G3”, “EXA-7311-G4”, “EXA-7311-G4S”, “HP-6000” (all manufactured by DIC Corporation, naphthylene ether type epoxy resin), “EPPN-502H” (manufactured by Nippon Kayaku Co., Ltd., trisphenol type epoxy resin), “NC-7000L”, “NC-7300” (all manufactured by Nippon Kayaku Co., Ltd., naphthol-cresol novolac type epoxy resin), “NC-3000H”, “NC-3000”, “NC-3000L”, “NC-3100” (all manufactured by Nippon Kayaku Co., Ltd., biphenyl ether type epoxy resin), arylalkyl type epoxy resin), “XD-1000-2L”, “XD-1000-L”, “XD-1000-H”, “XD-1000-H” (all manufactured by Nippon Kayaku Co., Ltd., dicyclopentadiene type epoxy resin), “ESN475V” (manufactured by Nippon Steel & Sumikin Chemical Co., Ltd., naphthol type epoxy resin), “ESN485” (manufactured by Nippon Steel & Sumikin Chemical Co., Ltd., naphthol novolac type epoxy resin), “YX-4000H”, “YX-4000”, “YL6121” (all manufactured by Mitsubishi Chemical Corporation, biphenyl type epoxy resin), “YX-4000HK” (manufactured by Mitsubishi Chemical Corporation, bixylenol type epoxy resin), “YX-8800” (manufactured by Mitsubishi Chemical Corporation, anthracene type epoxy resin), “PG-100”, “CG-500” (manufactured by Osaka Gas Chemical Co., Ltd., fluorene type epoxy resin), “YL-7760” (manufactured by Mitsubishi Chemical Corporation, bisphenol AF type epoxy resin), “YL-7800” (manufactured by Mitsubishi Chemical Corporation, fluorene type epoxy resin), “jER1010” (manufactured by Mitsubishi Chemical Corporation, solid bisphenol A type epoxy resin), “jER1031S” (manufactured by Mitsubishi Chemical Corporation, tetraphenylethane type epoxy resin), etc. These may be used alone or in combination of two or more.

### [Active Ester Compound]

The active ester compound refers to a compound that contains at least one ester bond in the structure and has an aliphatic chain, an aliphatic ring, or an aromatic ring bonded to both sides of the ester bond. Examples of the active ester compound include compounds having two or more highly reactive ester groups in one molecule, such as phenol esters, thiophenol esters, N-hydroxyamine esters, and esters of heterocyclic hydroxy compounds, and are obtained by a condensation reaction between at least one compound of a carboxylic acid compound, an acid chloride, or a thiocarboxylic acid compound and at least one compound of a hydroxy compound or a thiol compound. In particular, from the viewpoint of improving heat resistance, it is preferable to obtain the active ester compound from a carboxylic acid compound or an acid chloride and a hydroxy compound, and the hydroxy compound is preferably a phenol compound or a naphthol compound. The active ester compound may be used alone or in combination of two or more types.

Examples of the carboxylic acid compound include benzoic acid, acetic acid, succinic acid, maleic acid, itaconic acid, phthalic acid, isophthalic acid, terephthalic acid, and pyromellitic acid.

Examples of the acid chloride include acetyl chloride, acrylic acid chloride, methacrylic acid chloride, malonyl chloride, succinic acid dichloride, diglycolyl chloride, glutaric acid dichloride, suberic acid dichloride, sebacic acid dichloride, adipic acid dichloride, dodecandioyl dichloride, azelaic acid chloride, 2,5-furandicarbonyl dichloride, phthaloyl chloride, isophthaloyl chloride, terephthaloyl chloride, trimesic acid chloride, bis(4-chlorocarbonylphenyl) ether, 4,4′-diphenyldicarbonyl chloride, and 4,4′-azodibenzoyl dichloride.

Examples of the phenol compound and naphthol compound include hydroquinone, resorcin, bisphenol A, bisphenol F, bisphenol S, phenolphthaline, methylated bisphenol A, methylated bisphenol F, methylated bisphenol S, phenol, o-cresol, m-cresol, p-cresol, catechol, α-naphthol, B-naphthol, 1,5-dihydroxynaphthalene, 1,6-dihydroxynaphthalene, 2,6-dihydroxynaphthalene, dihydroxy benzophenone, trihydroxy benzophenone, tetrahydroxy benzophenone, phloroglucin, benzenetriol, dicyclopentadiene-type diphenol compound, phenol novolak, and phenol resins described below. Here, the term “dicyclopentadiene-type diphenol compound” refers to a diphenol compound obtained by condensing one molecule of dicyclopentadiene with two molecules of phenol.

Preferred specific examples of the active ester compound include an active ester compound containing a dicyclopentadiene-type diphenol structure, an active ester compound containing a naphthalene structure, an active ester compound containing an acetylated product of phenol novolac, an active ester compound containing a benzoylated product of phenol novolac, a compound described in Example 2 of WO 2020/095829, and a compound disclosed in WO 2020/059625. Among them, an active ester compound containing a naphthalene structure and an active ester compound containing a dicyclopentadiene-type diphenol structure are more preferred. The dicyclopentadiene-type diphenol structure refers to a divalent structural unit consisting of phenylene-dicyclopentylene-phenylene.

Commercially available active ester compounds include, for example, active ester compounds containing a dicyclopentadiene-type diphenol structure such as “EXB9451”, “EXB9460”, “EXB9460S”, “HPC-8000-65T”, “HPC-8000H-65TM”, “EXB-8000L-65TM”, and “EXB-8150-65T” (manufactured by DIC Corporation), active ester compounds containing a naphthalene structure such as “EXB9416-70BK” (manufactured by DIC Corporation), and phenolic Examples of active ester compounds containing an acetylated phenol novolac include “DC808” (manufactured by Mitsubishi Chemical Corporation), active ester compounds containing a benzoylated phenol novolac include “YLH1026”, “YLH1030”, and “YLH1048” (manufactured by Mitsubishi Chemical Corporation), an active ester curing agent which is an acetylated phenol novolac, such as “DC808” (manufactured by Mitsubishi Chemical Corporation), and an active ester curing agent containing a phosphorus atom such as “EXB-9050L-62M” (manufactured by DIC Corporation).

### [Phenol Resin]

Phenol resin is a compound having two or more phenolic hydroxy groups in the molecule. Examples of phenol resin include, but are not limited to, reaction products of phenols and aldehydes, reaction products of phenols and diene compounds, reaction products of phenols and ketones, reaction products of phenols and substituted biphenyls, reaction products of phenols and substituted phenyls, reaction products of bisphenols and aldehydes, etc. Furthermore, these may be used alone or in combination.

Specific examples of the above raw materials are shown below, but are not limited to these.

### <Phenols>

Phenol, alkyl-substituted phenol, aromatic-substituted phenol, hydroquinone, resorcin, naphthol, alkyl-substituted naphthol, dihydroxybenzene, alkyl-substituted dihydroxybenzene, dihydroxynaphthalene, etc.

### <Aldehydes>

Formaldehyde, acetaldehyde, alkyl aldehyde, benzaldehyde, alkyl-substituted benzaldehyde, hydroxybenzaldehyde, naphthaldehyde, glutaraldehyde, phthalaldehyde, crotonaldehyde, cinnamaldehyde, furfural, etc.

### <Diene Compounds>

Dicyclopentadiene, terpenes, vinylcyclohexene, norbornadiene, vinylnorbomene, tetrahydroindene, divinylbenzene, divinylbiphenyl, diisopropenylbiphenyl, butadiene, isoprene, etc.

### <Ketones>

Acetone, methyl ethyl ketone, methyl isobutyl ketone, acetophenone, benzophenone, fluorenone, etc.

### <Substituted Biphenyls>

4,4′-bis(chloromethyl)-1,1′-biphenyl, 4,4′-bis(methoxymethyl)-1,1′-biphenyl, 4,4′-bis(hydroxymethyl)-1,1′-biphenyl, etc.

### <Substituted Phenyls>

1,4-bis(chloromethyl)benzene, 1,4-bis(methoxymethyl)benzene, 1,4-bis(hydroxymethyl)benzene, etc.

### [Polyphenylene Ether Compound]

From the viewpoint of heat resistance and electrical properties, the polyphenylene ether compound is preferably a polyphenylene ether compound having an ethylenically unsaturated bond, and more preferably a polyphenylene ether compound having an acrylic group, a methacrylic group, or a styrene structure. Commercially available products include SA-9000 (manufactured by SABIC, a polyphenylene ether compound having a methacrylic group) and OPE-2St 1200 (manufactured by Mitsubishi Gas Chemical Co., Ltd., a polyphenylene ether compound having a styrene structure).

The number average molecular weight (Mn) of the polyphenylene ether compound is preferably 500 to 5000, more preferably 2000 to 5000, and more preferably 2000 to 4000. If the molecular weight is less than 500, the heat resistance of the cured product tends to be insufficient. In addition, if the molecular weight is more than 5000, the melt viscosity becomes high and sufficient fluidity cannot be obtained, which tends to cause molding defects. In addition, the reactivity is also reduced, the curing reaction takes a long time, and the amount of unreacted compounds not incorporated into the curing system increases, which leads to a decrease in the glass transition temperature of the cured product and a decrease in the heat resistance of the cured product.

If the number average molecular weight of the polyphenylene ether compound is 500 to 5000, excellent heat resistance and moldability can be achieved while maintaining excellent dielectric properties. The number average molecular weight here can be specifically measured using gel permeation chromatography or the like.

The polyphenylene ether compound may be one obtained by a polymerization reaction, or one obtained by a redistribution reaction of a high molecular weight polyphenylene ether compound having a number average molecular weight of about 10,000 to 30,000. In addition, these may be used as raw materials and reacted with a compound having an ethylenically unsaturated bond, such as methacryl chloride, acrylic chloride, or chloromethylstyrene, to impart radical polymerizability. The polyphenylene ether compound obtained by the redistribution reaction is obtained, for example, by heating a high molecular weight polyphenylene ether compound in a solvent such as toluene in the presence of a phenolic compound and a radical initiator to cause a redistribution reaction. The polyphenylene ether compound obtained by the redistribution reaction in this way has hydroxy groups derived from a phenolic compound that contributes to curing at both ends of the molecular chain, and is therefore preferable in that it can maintain even higher heat resistance, and that functional groups can be introduced at both ends of the molecular chain even after modification with a compound having an ethylenically unsaturated bond. In addition, the polyphenylene ether compound obtained by the polymerization reaction is preferable in that it exhibits excellent fluidity.

The molecular weight of the polyphenylene ether compound can be adjusted by adjusting the polymerization conditions, etc., in the case of a polyphenylene ether compound obtained by a polymerization reaction. In addition, in the case of a polyphenylene ether compound obtained by a redistribution reaction, the molecular weight of the obtained polyphenylene ether compound can be adjusted by adjusting the conditions, etc., of the redistribution reaction. More specifically, it is possible to adjust the amount of the phenolic compound used in the redistribution reaction. That is, the greater the amount of the phenolic compound, the lower the molecular weight of the obtained polyphenylene ether compound. In this case, poly(2,6-dimethyl-1,4-phenylene ether) or the like can be used as the high molecular weight polyphenylene ether compound that undergoes the redistribution reaction. In addition, the phenolic compound used in the redistribution reaction is not particularly limited, but for example, a polyfunctional phenolic compound having two or more phenolic hydroxy groups in the molecule, such as bisphenol A, phenol novolac, cresol novolac, etc., is preferably used. These may be used alone or in combination of two or more.

### [Amine Resin]

Amine resin is a compound having two or more amino groups in the molecule. Examples of amine resins include, but are not limited to: diaminodiphenylmethane, diaminodiphenylsulfone, isophoronediamine, naphthalenediamine, aniline novolak (a reaction product of aniline and formalin), N-methylaniline novolak (a reaction product of N-methylaniline and formalin), orthoethylaniline novolak (a reaction product of orthoethylaniline and formalin), a reaction product of 2-methylaniline and formalin, a reaction product of 2,6-diisopropylaniline and formalin, a reaction product of 2,6-diethylaniline and formalin, a reaction product of 2-ethyl-6-ethylaniline and formalin, a reaction product of 2,6-dimethylaniline and formalin, and a reaction product obtained by reacting aniline and xylylene chloride; reaction products of aniline resin disclosed in Japanese Patent No. 6429862 with substituted biphenyls such as 4,4′-bis(chloromethyl)-1, l′-biphenyl and 4,4′-bis(methoxymethyl)-1, l′-biphenyl, etc.; reaction products of aniline with substituted phenyls such as 1,4-bis(chloromethyl)benzene, 1,4-bis(methoxymethyl)benzene and 1,4-bis(hydroxymethyl)benzene, etc.; reaction products of 4,4′-(1,3-phenylenediisopropylidene)bisaniline, 4,4′-(1,4-phenylenediisopropylidene)bisaniline, or aniline with diisopropenylbenzene; and dimer diamine, etc. Furthermore, these may be used alone or in combination.

### [Compound Containing an Ethylenically Unsaturated Bond]

The compound containing an ethylenically unsaturated bond is a compound that has one or more ethylenically unsaturated bonds in the molecule that can be polymerized by heat or light, regardless of whether a polymerization initiator is used or not.

Examples of the compound containing an ethylenically unsaturated bond include, but are not limited to: a reaction product of the phenol resin with an ethylenically unsaturated bond-containing halogen-based compound (chloromethylstyrene, allyl chloride, methallyl chloride, acrylic acid chloride, methacrylic acid chloride, etc.), a reaction product of an ethylenically unsaturated bond-containing phenol (2-allylphenol, 2-propenylphenol, 4-allylphenol, 4-propenylphenol, eugenol, isoeugenol, etc.) with a halogen-based compound (1,4-bis(chloromethyl)benzene, 4,4′-bis(chloromethyl)biphenyl, 4,4′-difluorobenzophenone, 4,4′-dichlorobenzophenone, 4,4′-dibromobenzophenone, cyanuric chloride, etc.), a reaction product of an epoxy resin or alcohol with a (meth)acrylic acid (acrylic acid, methacrylic acid, etc.), and an acid-modified product thereof. In addition, these may be used alone or in combination.

### [Isocyanate Resin]

An isocyanate resin is a compound having two or more isocyanate groups in the molecule. Examples of the isocyanate resin include aromatic diisocyanates such as p-phenylene diisocyanate, m-phenylene diisocyanate, p-xylylene diisocyanate, m-xylylene diisocyanate, 2,4-tolylene diisocyanate, 2,6-tolylene diisocyanate, 4,4′-diphenylmethane diisocyanate, and naphthalene diisocyanate; aliphatic or alicyclic diisocyanates such as isophorone diisocyanate, hexamethylene diisocyanate, 4,4′-dicyclohexylmethane diisocyanate, hydrogenated xylene diisocyanate, norbornene diisocyanate, and lysine diisocyanate; polyisocyanates such as one or more biuret forms of isocyanate monomers or isocyanate forms obtained by trimerizing the diisocyanate compounds; and polyisocyanates obtained by a urethanization reaction between the isocyanate compounds and polyol compounds, but are not limited thereto. These may be used alone or in combination.

### [Polyamide Resin]

Examples of polyamide resins include reaction products of one or more of diamines, diisocyanates, and oxazolines with dicarboxylic acids, reaction products of diamines with acid chlorides, and ring-opening polymers of lactam compounds. These may be used alone or in combination.

Specific examples of the above-mentioned raw materials are shown below, but are not limited to these.

### <Diamines>

Ethylenediamine, trimethylenediamine, tetramethylenediamine, pentamethylenediamine, hexamethylenediamine, heptamethylenediamine, octamethylenediamine, nonamethylenediamine, decanediamine, undecanediamine, dodecanediamine, tridecanediamine, tetradecanediamine, pentadecanediamine, hexadecanediamine, heptadecanediamine, octadecanediamine, nonadecanediamine, eicosanediamine, 2-methyl-1,5-diaminopentane, 2-methyl-1,8-diaminooctane, dimer diamine, cyclohexane diamine, bis-(4-aminocyclohexyl)methane, bis(3-methyl-4-aminocyclohexyl)methane, xylylene diamine, norbomnane diamine, isophorone diamine, bisaminomethyltricyclodecane, phenylenediamine, diethyltoluenediamine, naphthalenediamine, diaminodiphenylmethane, bis(4-amino-3,5-dimethylphenyl)methane bis(4-amino-3,5-diethylphenyl)methane, 4,4′-methylenebis-o-toluidine, 4,4′-methylenebis-o-ethylaniline, 4,4′-methylenebis-2-ethyl-6-methylaniline, 4,4′-methylenebis-2,6-diisopropylaniline, 4,4-ethylenedianiline, diaminodiphenyl sulfone, diaminodiphenyl ether, 1,3-bis(3-aminophenoxy)benzene, 1,3-bis(4-aminophenoxy)benzene, 4,4-bis(4-aminophenoxy)biphenyl, 2,2-bis[4-(4-aminophenoxy)phenyl]propane, bis[4-(4-aminophenoxy)phenyl]sulfone, 2,2-bis(3-amino-4-hydroxyphenyl)propane, 2,2-bis(4-aminophenyl)hexafluoropropane, 4,4′-(1,3-phenylenediisopropylidene)bisaniline, 4,4′-(1,4-phenylenediisopropylidene)bisaniline, 9,9-bis(4-aminophenyl) fluorene, 2,7-diaminofluorene, aminobenzylamine, diaminobenzophenone, and the like.

### <Diisocyanates>

benzene diisocyanate, toluene diisocyanate, 1,3-bis(isocyanatomethyl)benzene, 1,3-bis(isocyanatomethyl)cyclohexane, bis(4-isocyanatophenyl)methane, isophorone diisocyanate, 1,3-bis(2-isocyanato-2-propyl)benzene, 2,2-bis(4-isocyanatophenyl)hexafluoropropane, dicyclohexylmethane-4,4′-diisocyanate, and the like.

### <Dicarboxylic Acids>

oxalic acid, malonic acid, succinic acid, glutaric acid, adipic acid, suberic acid, azelaic acid, sebacic acid, undecanedioic acid, dodecanedioic acid, terephthalic acid, isophthalic acid, 5-hydroxyisophthalic acid, 2-chloroterephthalic acid, 2-methylterephthalic acid, 5-methylisophthalic acid, 5-sodium sulfoisophthalic acid, hexahydroterephthalic acid, hexahydroisophthalic acid, cyclohexanedicarboxylic acid, biphenyldicarboxylic acid, naphthalenedicarboxylic acid, benzophenonedicarboxylic acid, furandicarboxylic acid, 4,4′-dicarboxydiphenyl ether, 4,4′-dicarboxydiphenyl sulfide, and the like.

### <Acid Chlorides>

acetyl chloride, acrylic acid chloride, methacrylic acid chloride, malonyl chloride, succinic acid dichloride, diglycolyl chloride, glutaric acid dichloride, suberic acid dichloride, sebacic acid dichloride, adipic acid dichloride, dodecandioyl dichloride, azelayl chloride, 2,5-furandicarbonyl dichloride, phthaloyl chloride, isophthaloyl chloride, terephthaloyl chloride, trimesic acid chloride, bis(4-chlorocarbonylphenyl) ether, 4,4′-diphenyldicarbonyl chloride, 4,4′-azodibenzoyl dichloride, etc.

### <Lactams>

ε-caprolactam, ω-undecanelactam, ω-laurolactam, etc.

### [Polyimide Resin]

Examples of polyimide resins include, but are not limited to, reaction products of the diamines described above with the following tetracarboxylic dianhydrides. These may be used alone or in combination.

### <Tetracarboxylic Dianhydrides>

4,4′-(hexafluoroisopropylidene)diphthalic anhydride, 5-(2,5-dioxotetrahydro-3-furanyl)-3-methyl-cyclohexene-1,2 dicarboxylic anhydride, pyromellitic dianhydride, 1,2,3,4-benzenetetracarboxylic dianhydride, 3,3′,4,4′-benzophenonetetracarboxylic dianhydride, 2,2′,3,3′-benzophenonetetracarboxylic dianhydride, 3,3′,4,4′-biphenyltetracarboxylic dianhydride, 3,3′,4,4′-diphenylsulfonate tetracarboxylic dianhydride, 2,2′,3,3′-biphenyltetracarboxylic dianhydride, methylene-4,4′-diphthalic dianhydride, 1,1-ethylidene-4,4′-diphthalic dianhydride, 2,2′-propylidene-4,4′-diphthalic dianhydride, 1,2-ethylene-4,4′-diphthalic dianhydride, 1,3-trimethylene-4,4′-diphthalic dianhydride, 1,4-tetramethylene-4,4′-diphthalic dianhydride, 1,5-pentamethylene-4,4′-diphthalic dianhydride, 4,4′-oxydiphthalic dianhydride Anhydride, thio-4,4′-diphthalic dianhydride, sulfonyl-4,4′-diphthalic dianhydride, 1,3-bis(3,4-dicarboxyphenyl)benzene dianhydride, 1,3-bis(3,4-dicarboxyphenoxy)benzene dianhydride, 1,4-bis(3,4-dicarboxyphenoxy)benzene dianhydride, 1,3-bis[2-(3,4-dicarboxyphenyl)-2-propyl]benzene dianhydride, 1,4-bis[2-(3,4-dicarboxyphenyl)-2-propyl]benzene dianhydride, bis[3-(3,4-dicarboxyphenoxy)phenyl]methane dianhydride, bis[4-(3,4-dicarboxyphenoxy)phenyl]methane dianhydride, 2,2-bis[3-(3,4-dicarboxyphenoxy)phenyl]propane dianhydride, 2,2-bis[4-(3,4-dicarboxyphenoxy)phenyl]propane dianhydride, bis(3,4-dicarboxyphenoxy)dimethylsilane dianhydride, 1,3-bis(3,4-dicarboxyphenyl)-1,1,3,3-tetramethyldisiloxane dianhydride, 2,3,6,7-naphthalene tetracarboxylic dianhydride, 1,4,5,8-naphthalene tetracarboxylic dianhydride, 1,2,5,6-naphthalene tetracarboxylic dianhydride, 3,4,9,10-perylene tetracarboxylic dianhydride, 2,3,6,7-anthracene tetracarboxylic dianhydride, 1,2,7,8-phenanthrene tetracarboxylic dianhydride, ethylene tetracarboxylic dianhydride, 1,2,3,4-butane tetracarboxylic dianhydride, 1,2,3,4-cyclobutane tetracarboxylic dianhydride), cyclopentane tetracarboxylic dianhydride, cyclohexane-1,2,3,4-tetracarboxylic dianhydride, cyclohexane-1,2,4,5-tetracarboxylic dianhydride, 3,3′,4,4′-bicyclohexyltetracarboxylic dianhydride, carbonyl-4,4′-bis(cyclohexane-1,2-dicarboxylic acid) dianhydride, methylene-4,4′-bis(cyclohexane-1,2-dicarboxylic acid) dianhydride, 1,2-ethylene-4,4′-bis(cyclohexane-1,2-dicarboxylic acid) dianhydride, 1,1-ethylidene-4,4′-bis(cyclohexane-1,2-dicarboxylic acid) dianhydride, 2,2-propylidene-4,4′-bis(cyclohexane-1,2-dicarboxylic acid) dianhydride, oxy-4,4′-bis(cyclohexane-1,2-dicarboxylic acid) dianhydride, thio-4,4′-bis(cyclohexane-1,2-dicarboxylic acid) dianhydride, sulfonyl-4,4′-bis(cyclohexane-1,2-dicarboxylic acid) dianhydride, bicyclo[2,2,2]oct-7-ene-2,3,5,6-tetracarboxylic acid dianhydride, rel-[1S,5R,6R]-3-oxabicyclo[3,2,1]octane-2,4-dione-6-spiro-3′-(tetrahydrofuran-2′,5′-dione), 4-(2,5-dioxotetrahydrofuran-3-yl)-1,2,3,4-tetrahydronaphthalene-1,2-dicarboxylic anhydride, ethylene glycol-bis-(3,4-dicarboxylic anhydride phenyl) ether, 4,4′-biphenyl bis(trimellitic acid monoester acid anhydride), 9,9′-bis(3,4-dicarboxyphenyl) fluorene dianhydride, and the like.

### [Maleimide Compound]

The curable resin composition of the present invention may contain a maleimide compound. A maleimide compound is a compound having one or more maleimide groups in the molecule. Examples of the maleimide compound include, but are not limited to: 4,4′-diphenylmethane bismaleimide, polyphenylmethane maleimide, m-phenylene bismaleimide, 2,2′-bis[4-(4-maleimidophenoxy)phenyl]propane, 3,3′-dimethyl-5,5′-diethyl-4,4′-diphenylmethane bismaleimide, 4-methyl-1,3-phenylene bismaleimide, 4,4′-diphenylether bismaleimide, 4,4′-diphenylsulfone bismaleimide, 1,3-bis(3-maleimidophenoxy)benzene, 1,3-bis(4-maleimidophenoxy)benzene), and Xylok type maleimide compounds (anilix maleimide, manufactured by Mitsui Chemicals Fine Co., Ltd.), biphenylaralkyl-type maleimide compound (solid obtained by distilling off the solvent under reduced pressure from a resin solution containing the maleimide compound (M2) described in Example 4 of JP 2009-001783 A), bisaminocumylbenzene-type maleimide (maleimide compound described in WO 2020/054601 A), maleimide compounds having an indane structure described in JP 6629692B, or WO2020/217679A, the maleimide compounds described in “Epoxy Resin CAS Number Story Continued-Hardener CAS Number Memorandum, No. 31 Bismaleimide (1)”, MATERIAL STAGE Vol. 18, No. 12, 2019, and “Epoxy Resin CAS Number Story Continued-Hardener CAS Number Memorandum, No. 32 Bismaleimide (2)”, MATERIAL STAGE Vol. 19, No. 32 in 2019. These compounds may be used alone or in combination.

### [Cyanate Ester Resin]

Cyanate ester resin is a cyanate ester compound obtained by reacting a phenol resin with a cyanogen halide. Specific examples include, but are not limited to: dicyanatobenzene, tricyanatobenzene, dicyanatonaphthalene, dicyanatobiphenyl, 2,2′-bis(4-cyanatophenyl)propane, bis(4-cyanatophenyl)methane, bis(3,5-dimethyl-4-cyanatophenyl)methane, 2,2′-bis(3,5-dimethyl-4-cyanatophenyl)propane, 2,2′-bis(4-cyanatophenyl)ethane, 2,2′-bis(4-cyanatophenyl)hexafluoropropane, bis(4-cyanatophenyl)sulfone, bis(4-cyanatophenyl)thioether, phenol novolac cyanate, and a compound obtained by substituting the hydroxy groups of phenol-dicyclopentadiene co-condensates product with cyanate groups. These may be used alone or in combination.

The cyanate ester compound, the synthesis method of which is described in JP-A-2005-264154, is particularly preferred as the cyanate ester compound, since it has low moisture absorption, flame retardancy, and excellent dielectric properties.

The cyanate ester resin may contain a catalyst such as zinc naphthenate, cobalt naphthenate, copper naphthenate, lead naphthenate, zinc octylate, tin octylate, lead acetylacetonate, or dibutyltin maleate, in order to trimerize the cyanate group to form a sym-triazine ring, as necessary.

The catalyst is preferably used in an amount of 0.0001 to 0.10 parts by mass, and more preferably 0.00015 to 0.0015 parts by mass, per 100 parts by mass of the cyanate ester resin.

### [Polybutadiene and its Modified Products]

Polybutadiene and its modified products are compounds having polybutadiene or a structure derived from polybutadiene in the molecule. The structure derived from polybutadiene may have some or all of the unsaturated bonds converted to single bonds by hydrogenation.

Examples of polybutadiene and its modified products include, but are not limited to, poly butadiene, hydroxy-terminated polybutadiene, (meth)acrylated polybutadiene, carboxylic acid-terminated polybutadiene, amine-terminated polybutadiene, styrene butadiene rubber, etc. Also, these may be used alone or in combination. Of these, poly butadiene or styrene butadiene rubber is preferred from the viewpoint of dielectric properties. Examples of styrene butadiene rubber (SBR) include RICON-100, RICON-181, and RICON-184 (all manufactured by Cray Valley Corporation), and 1,2-SBS (manufactured by Nippon Soda Co., Ltd.). Examples of polybutadiene include B-1000, B-2000, and B-3000 (all manufactured by Nippon Soda Co., Ltd.). The molecular weight of polybutadiene and styrene butadiene rubber is preferably a weight average molecular weight of 500 to 10,000, more preferably 750 to 7,500, and even more preferably 1,000 to 5,000. Below the lower limit of the above range, the amount of volatilization is large, making it difficult to adjust the solid content when preparing the prepreg, and above the upper limit of the above range, compatibility with other curable resins is deteriorated. In general, in the case of compounds containing heteroatoms such as oxygen and nitrogen, such as bismaleimide and polymaleimide, it is difficult to ensure compatibility with low-polarity compounds such as compounds mainly composed of hydrocarbons or compounds composed only of hydrocarbons due to their polarity. On the other hand, the compound of the present invention has a skeleton design that does not include a heteroatom such as oxygen or nitrogen, and therefore has excellent compatibility with materials having low polarity and low dielectric properties and with compounds composed only of hydrocarbons.

### [Polystyrene and Modified Products Thereof]

Polystyrene and modified products thereof are polystyrene or compounds having a structure derived from polystyrene in the molecule.

Examples of polystyrene and modified products thereof include, but are not limited to: polystyrene, styrene-2-isopropenyl-2-oxazoline copolymers (Epocross RPS-1005, RP-61, both manufactured by Nippon Shokubai Co., Ltd.), SEP (styrene-ethylene-propylene copolymer: Septon 1020, manufactured by Kuraray Co., Ltd.), SEPS (styrene-ethylene-propylene-styrene copolymer: Septon 2002, Septon 2004F, Septon 2005, Septon 2006, Septon 2063, Septon 2104, all manufactured by Kuraray Co., Ltd.), SEEPS (styrene-ethylene/ethylene-propylene-styrene block copolymer: Septon 4003, Septon 4044, Septon 4055, Septon 4077, Septon 4099, all manufactured by Kuraray Co., Ltd.), SEBS (styrene-ethylene-butylene-styrene block copolymer: Septon 8004, Septon 8006, Septon 8007L, all manufactured by Kuraray Co., Ltd.), SEEPS-OH (a styrene-ethylene/ethylene propylene-styrene block copolymer having a hydroxy group at the end: SEPTON HG252, manufactured by Kuraray Co., Ltd.), SIS (styrene-isoprene-styrene block copolymer: SEPTON 5125, SEPTON 5127, manufactured by Kuraray Co., Ltd.), hydrogenated SIS (hydrogenated styrene-isoprene-styrene block copolymer: HYBRAR 7125F, HYBRAR 7311F, manufactured by Kuraray Co., Ltd.), SIBS (styrene-isobutylene-styrene block copolymer: SIBSTAR073T, SIBSTAR102T, SIBSTAR103T (all manufactured by Kaneka Corporation), SEPTON V9827 (manufactured by Kuraray Co., Ltd.)). These may be used alone or in combination. Polystyrene and modified products thereof have higher heat resistance and are less susceptible to oxidative deterioration, so it is preferable that they do not have unsaturated bonds. The weight-average molecular weight of polystyrene and modified products thereof is not particularly limited as long as it is 10,000 or more, but if it is too large, the compatibility with not only polyphenylene ether compounds but also low molecular weight components with a weight-average molecular weight of about 50 to 1,000 and oligomer components with a weight-average molecular weight of about 1,000 to 5,000 deteriorates, making it difficult to ensure mixing and solvent stability, so it is preferably about 10,000 to 300,000.

### [Polyethylene and Modified Products Thereof]

Polyethylene and modified products thereof are compounds having polyethylene or a structure derived from polyethylene in the molecule. Examples of polyethylene and modified products thereof include ethylene-propylene copolymers, ethylene-styrene copolymers, ethylene-propylene-ethylidene norbornene copolymers (EBT: K-8370EM, K-9330M, etc., manufactured by Mitsui Chemicals, Inc.), ethylene-propylene-vinyl norbornene copolymers (VNB-EPT: PX-006M, PX-008M, PX-009M, etc., manufactured by Mitsui Chemicals, Inc.), ethylene-vinyl alcohol copolymers, ethylene-vinyl acetate copolymers, etc., but are not limited thereto. From the viewpoint of improving heat resistance, it is preferable to use ethylene-propylene-ethylidene norbornene copolymers and ethylene-propylene-vinyl norbornene copolymers containing a crosslinkable structure. In addition, these may be used alone or in combination. The weight average molecular weight of the polyethylene and modified products thereof is not particularly limited as long as it is 10,000 or more. However, if it is too large, compatibility with not only the polyphenylene ether compound but also low molecular weight components having a weight average molecular weight of about 50 to 1,000 and oligomer components having a weight average molecular weight of about 1,000 to 5,000 deteriorates, making it difficult to ensure mixing and solvent stability. Therefore, it is preferably about 10,000 to 300,000.

The curable resin composition of the present invention can be obtained by preparing the above-mentioned components in a predetermined ratio, pre-curing the composition at 130 to 180° C. for 30 to 500 seconds, and then post-curing the composition for 2 to 15 hours at 150 to 200° C., whereby the curing reaction proceeds sufficiently to obtain the cured product of the present invention. Alternatively, the components of the curable resin composition can be uniformly dispersed or dissolved in a solvent or the like, and cured after removing the solvent.

The method for preparing the curable resin composition of the present invention is not particularly limited, but each component may be mixed uniformly or may be prepolymerized. For example, a mixture containing the compound of the present invention is heated in the presence or absence of a curing accelerator or a polymerization initiator, and in the presence or absence of a solvent to form a prepolymer. Similarly, an amine compound, a compound having an ethylenically unsaturated bond, a maleimide compound, a cyanate ester compound, polybutadiene and its modified products, polystyrene and its modified products, inorganic fillers, and other additives may be added to form a prepolymer. The mixing or prepolymerization of each component is carried out using, for example, an extruder, a kneader, a roll, etc. in the absence of a solvent, and a reaction kettle with a stirrer, etc. in the presence of a solvent.

As a method of uniform mixing, the materials are mixed at a temperature in the range of 50 to 100° C. by kneading with a device such as a kneader, roll, or planetary mixer to obtain a uniform resin composition. The obtained resin composition is crushed and then molded into a cylindrical tablet shape using a molding machine such as a tablet machine, or into a granular powder or powder molded body, or these compositions can be melted on a surface support and molded into a sheet shape with a thickness of 0.05 mm to 10 mm to obtain a molded curable resin composition. The obtained molded body is a non-sticky molded body at 0 to 20° C., and even if stored at −25 to 0° C. for one week or more, the flowability and curability are hardly reduced.

The obtained molded body can be molded into a cured product using a transfer molding machine or a compression molding machine.

The curable resin composition of the present invention can be made into a varnish-like composition (hereinafter, simply referred to as varnish) by adding an organic solvent. The curable resin composition of the present invention can be dissolved in a solvent such as toluene, xylene, acetone, methyl ethyl ketone, methyl isobutyl ketone, dimethylformamide, dimethylacetamide, N-methylpyrrolidone, etc. as necessary to make a varnish, and impregnated into a substrate such as glass fiber, carbon fiber, polyester fiber, polyamide fiber, alumina fiber, paper, etc., and dried by heating to obtain a prepreg, which can be hot-press molded to obtain a cured product of the curable resin composition of the present invention. The solvent used in this case is in an amount that occupies 10 to 70% by weight, preferably 15 to 70% by weight, in the mixture of the curable resin composition of the present invention and the solvent. In addition, if the composition is in a liquid state, a cured product of the curable resin containing carbon fiber can be obtained as it is, for example, by the RTM method.

The curable resin composition of the present invention can also be used as a modifier for a film-type composition. Specifically, it can be used to improve flexibility and the like in the B-stage. Such a film-type resin composition can be obtained as a sheet-like adhesive by applying the curable resin composition of the present invention as the curable resin composition vamish onto a release film, removing the solvent under heating, and then performing B-stage formation. This sheet-like adhesive can be used as an interlayer insulating layer in a multilayer substrate or the like.

The curable resin composition of the present invention can be heated and melted to reduce the viscosity, and impregnated into reinforcing fibers such as glass fibers, carbon fibers, polyester fibers, polyamide fibers, and alumina fibers to obtain a prepreg. Specific examples thereof include glass fibers such as E glass cloth, D glass cloth, S glass cloth, Q glass cloth, spherical glass cloth, NE glass cloth, and T glass cloth, inorganic fibers other than glass, and organic fibers such as polyparaphenylene terephthalamide (Kevlar (registered trademark), manufactured by DuPont), fully aromatic polyamide, polyester, polyparaphenylene benzoxazole, polyimide, and carbon fibers, but are not particularly limited thereto. The shape of the substrate is not particularly limited, but examples thereof include woven fabric, nonwoven fabric, roving, chopped strand mat, and the like. In addition, as the weaving method of the woven fabric, plain weave, saddle weave, twill weave, and the like are known, and these known weaves can be appropriately selected and used depending on the intended use and performance. In addition, woven fabrics that have been subjected to fiber opening treatment and glass woven fabrics that have been surface-treated with a silane coupling agent or the like are preferably used. The thickness of the substrate is not particularly limited, but is preferably about 0.01 to 0.4 mm. A prepreg can also be obtained by impregnating reinforcing fibers with the varnish and drying the fibers by heating.

Moreover, a laminate can be manufactured using the prepreg. The laminate is not particularly limited as long as it has one or more prepregs, and may have any other layer. The manufacturing method of the laminate can be appropriately applied by a generally known method, and is not particularly limited. For example, when molding a metal foil-clad laminate, a multi-stage press machine, a multi-stage vacuum press machine, a continuous molding machine, an autoclave molding machine, etc. can be used, and the prepregs are laminated together and heated and pressurized to obtain a laminate. At this time, the heating temperature is not particularly limited, but is preferably 65 to 300° C., and more preferably 120 to 270° C. In addition, the pressure to be applied is not particularly limited, but if the pressure is too high, it is difficult to adjust the solid content of the resin of the laminate, and the quality is not stable, and if the pressure is too low, air bubbles and adhesion between the laminates are deteriorated, so that 2.0 to 5.0 MPa is preferable, and 2.5 to 4.0 MPa is more preferable. The laminate of this embodiment can be suitably used as a metal foil-clad laminate described later by providing a layer made of metal foil.

The prepreg is cut into a desired shape and laminated with copper foil or the like as necessary. The laminate is then heated and cured while applying pressure thereto by press molding, autoclave molding, sheet winding molding or the like, to obtain an electrical and electronic laminate (printed wiring board) or a carbon fiber reinforced material.

The curable resin composition of the present invention can also be made into a resin sheet. As a method for obtaining a resin sheet from the curable resin composition of the present invention, for example, a method of applying the curable resin composition onto a support film (support), followed by drying, and forming a resin composition layer on the support film can be mentioned. When the curable resin composition of the present invention is used for a resin sheet, it is essential that the film softens under the temperature conditions (70° C. to 140° C.) for lamination in the vacuum lamination method, and exhibits a fluidity (resin flow) that allows resin filling of via holes or through holes present in the circuit board at the same time as lamination of the circuit board, and it is preferable to blend each of the above components so as to express such characteristics. In addition, in the obtained resin sheet or circuit board (copper-clad laminate, etc.), a phenomenon that locally different characteristic values are exhibited due to phase separation or the like does not occur, and a certain performance is expressed at any part, so that a uniform appearance is required.

Here, the diameter of the through-holes in the circuit board is 0.1 to 0.5 mm, and the depth is 0.1 to 1.2 mm, and it is preferable to make it possible to fill the resin within this range. When laminating both sides of the circuit board, it is preferable to fill about ½ of the through-holes.

A specific method for producing the resin sheet includes preparing a resin composition varnished by blending an organic solvent, applying the varnished resin composition to the surface of a support film (Y), and then drying the organic solvent by heating or blowing hot air or the like to form a resin composition layer (X).

As the organic solvent used here, for example, ketones such as acetone, methyl ethyl ketone, cyclohexanone, etc., acetate esters such as ethyl acetate, butyl acetate, cellosolve acetate, propylene glycol monomethyl ether acetate, carbitol acetate, etc., carbitols such as cellosolve, butyl carbitol, etc., aromatic hydrocarbons such as toluene, xylene, etc., dimethylformamide, dimethylacetamide, N-methylpyrrolidone, etc. are preferably used, and it is also preferable to use the organic solvent in a proportion such that the nonvolatile content is 30 to 60 mass %.

The thickness of the resin composition layer (X) formed must be equal to or greater than the thickness of the conductor layer. Since the thickness of the conductor layer of the circuit board is in the range of 5 to 70 μm, the thickness of the resin composition layer (X) is preferably 10 to 100 μm. The resin composition layer (X) in the present invention may be protected with a protective film described below. By protecting the resin composition layer with a protective film, it is possible to prevent the adhesion of dirt and the like to the surface of the resin composition layer and scratches.

The support film and the protective film may be made of a polyolefin such as polyethylene, polypropylene, or polyvinyl chloride, a polyester such as polyethylene terephthalate (PET) or polyethylene naphthalate, a polycarbonate, or a polyimide, or may be a release paper or a metal foil such as a copper foil or an aluminum foil. The support film and the protective film may be subjected to a release treatment in addition to a matte processing or a corona treatment. The thickness of the support film is not particularly limited, but is in the range of 10 to 150 μm, and preferably 25 to 50 μm. The thickness of the protective film is preferably 1 to 40 μm.

The support film (Y) is peeled off after laminating it onto a circuit board or after forming an insulating layer by heat curing. If the support film (Y) is peeled off after the resin composition layer constituting the resin sheet is heat cured, adhesion of dust and the like during the curing process can be prevented. When peeling off after curing, the support film is previously subjected to a release treatment.

Incidentally, a multilayer printed circuit board can be manufactured from the resin sheet obtained as described above. For example, when the resin composition layer (X) is protected by a protective film, the protective film is peeled off, and then the resin composition layer (X) is laminated on one or both sides of the circuit board so as to be in direct contact with the circuit board, for example, by a vacuum lamination method. The lamination method may be a batch type or a continuous type using a roll. If necessary, the resin sheet and the circuit board may be heated (preheated) before lamination. The lamination conditions are preferably a pressure bonding temperature (lamination temperature) of 70 to 140° C., a pressure bonding pressure of 1 to 11 kgf/cm² (9.8×10⁴ to 107.9×10⁴ N/m²), and lamination is preferably performed under reduced pressure of 20 mmHg (26.7 hPa) or less air pressure.

A semiconductor device can be manufactured using the curable resin composition of the present invention. Examples of the semiconductor device include: a dual in-line package (DIP), a quad flat package (QFP), a ball grid array (BGA), a chip size package (CSP), a small outline package (SOP), a thin small outline package (TSOP), a thin quad flat package (TQFP), etc.

The curable resin composition of the present invention and its cured product can be used in a wide range of fields. Specifically, it can be used in various applications such as molding materials, adhesives, composite materials, and paints. The cured product of the curable resin composition of the present invention exhibits excellent heat resistance and dielectric properties, and is therefore suitable for use in: electrical and electronic components such as semiconductor element encapsulants, liquid crystal display element encapsulants, organic EL element encapsulants, laminates (printed wiring boards, BGA substrates, build-up substrates, etc.); lightweight and high-strength structural composite materials such as carbon fiber reinforced plastics and glass fiber reinforced plastics; and 3D printing, etc.

### EXAMPLES

The present invention will now be described in more detail with reference to examples. Unless otherwise specified, all parts are by weight. However, the present invention is not limited to these examples.

The various analytical methods used in the examples are described below.

### <High Performance Liquid Chromatography (HP-LC)>

HP-LC: A liquid delivery unit (LC-20AB), online degasser (DGU-20A3), autosampler (SIL-20A), column oven (CTO-20A), system controller (CBM-20A), and photodiode array detector (SPD-M20A) (all manufactured by Shimadzu Corporation) were used.
Column: ODS-2 (manufactured by GL Sciences)
Eluent: tetrahydrofuran:water-3:1 (no gradient)
Flow rate: 0.5 ml/min.
Column temperature: 40° C.
Detection: PDA (photodiode array detector)

### Example 1

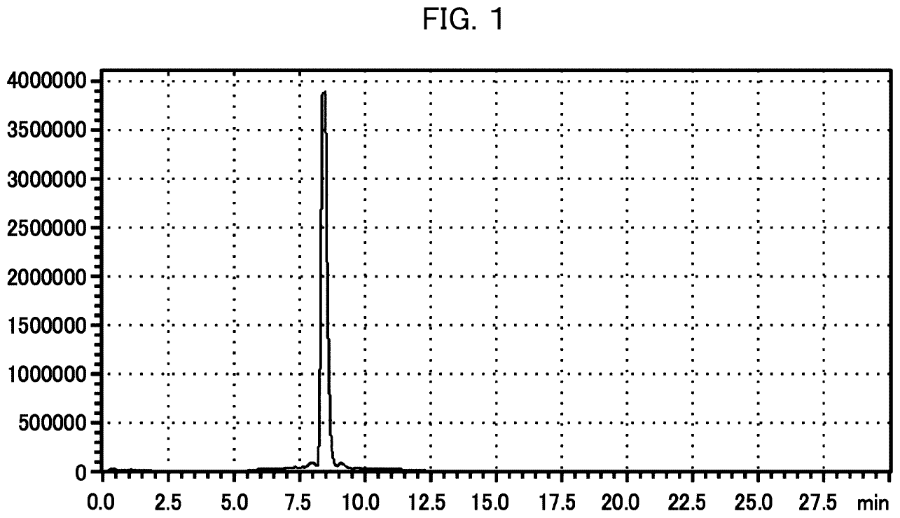

While purging with nitrogen into a flask equipped with a thermometer, a cooling tube, and a stirrer, 200 parts of dimethyl sulfoxide (hereinafter also referred to as DMSO), 33.3 parts of fluorene, and 24 parts of sodium hydroxide were added and stirred at 35° C. for 30 minutes. Then, while keeping the internal temperature at 40° C. or less, 58.0 parts of CMS-14 (manufactured by AGC Seimi Chemical Co., Ltd., a mixture of 4-chloromethylstyrene and 3-chloromethylstyrene, 4-chloromethylstyrene: 3-chloromethylstyrene=95:5 (mol ratio), purity 96.87 wt %) was dropped over 1 hour, and the reaction was carried out at 40° C. for 12 hours. 200 parts of methanol and 100 parts of water were added to crystallize, and the crystals were collected by filtration. The collected crystals were dissolved in 200 parts of toluene, and the organic layer was washed four times with 100 parts of water. The obtained organic layer was concentrated to obtain 76.9 parts of compound (A1). When the molecular weight of fluorene is 166.22, and the molecular weights of 4-chloromethylstyrene and 3-chloromethylstyrene are 152.62, the calculation is (β1+β2)/α=(58.0×0.9687/152.62)/(33.3/166.22)=1.84. In addition, β1/β2=95/5=19. The HP-LC chart of the obtained compound (A1) is shown in FIG. 1.

### Example 2

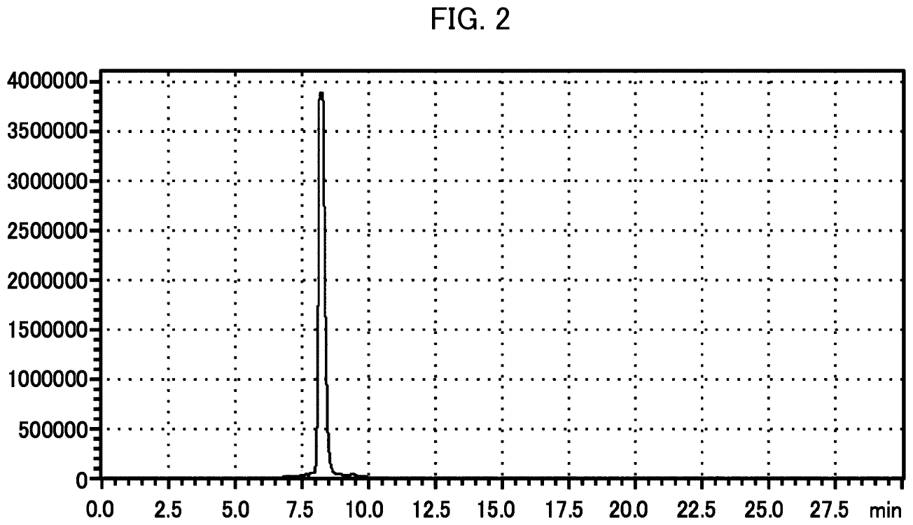

While purging with nitrogen into a flask equipped with a thermometer, a condenser, and a stirrer, 200 parts of DMSO, 33.3 parts of fluorene, and 24 parts of sodium hydroxide were added and stirred at 35° C. for 30 minutes. Then, while keeping the internal temperature at 40° C. or less, 58.0 parts of CMS-P (manufactured by AGC Seimi Chemical Co., Ltd., a mixture of 4-chloromethylstyrene and 3-chloromethylstyrene, 4-chloromethylstyrene:3-chloromethylstyrene=1:1 (mol ratio), purity 95.59 wt %) was dropped over 1 hour, and the mixture was reacted at 40° C. for 20 hours. 200 parts of methanol and 100 parts of water were added to crystallize, and the crystals were collected by filtration. The collected crystals were dissolved in 200 parts of toluene, and the organic layer was washed five times with 100 parts of water. The obtained organic layer was concentrated to obtain 56.4 parts of compound (A2). When the molecular weight of fluorene is 166.22, and the molecular weights of 4-chloromethylstyrene and 3-chloromethylstyrene are 152.62, the calculation is (β1+β2)/α=(58.0×0.9559/152.62)/(33.3/166.22)=1.81. In addition, β1/β2=β1/1=1. The HP-LC chart of the obtained compound (A2) is shown in FIG. 2.

### Example 3

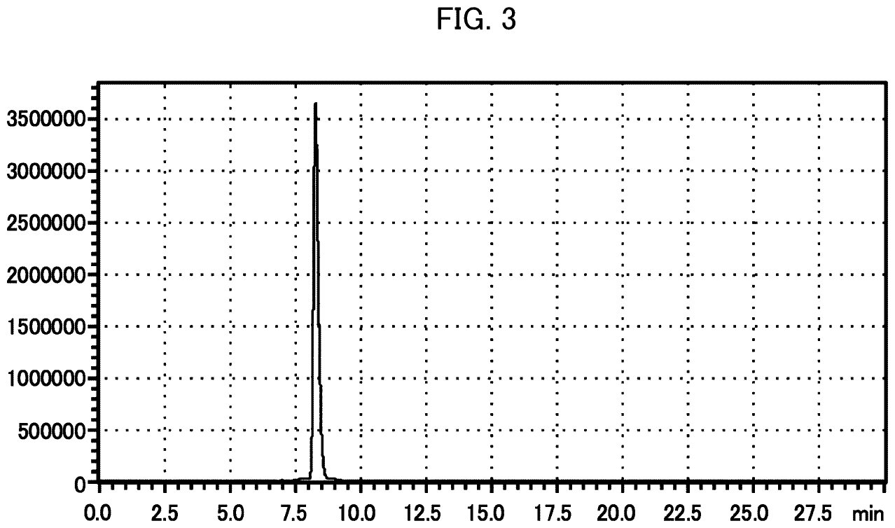

100 parts of DMSO, 33.3 parts of fluorene, and 24 parts of sodium hydroxide were added to a flask equipped with a thermometer, a condenser, and a stirrer while purging with nitrogen, and the mixture was stirred at 35° C. for 30 minutes. Then, while keeping the internal temperature at 40° C. or less, 61.0 parts of CMS-14 (manufactured by AGC Seimi Chemical Co., Ltd., a mixture of 4-chloromethylstyrene and 3-chloromethylstyrene, 4-chloromethylstyrene content: 3-chloromethylstyrene content=95:5, purity 96.87%) was added dropwise over 1 hour, and the mixture was reacted at 40° C. for 6 hours. 200 parts of methanol and 100 parts of water were added to crystallize, and the crystals were collected by filtration. The collected crystals were dissolved in 150 parts of toluene, and the organic layer was washed four times with 100 parts of water. The obtained organic layer was concentrated to obtain 58.0 parts of compound (A3). When the molecular weight of fluorene is 166.22, and the molecular weights of 4-chloromethylstyrene and 3-chloromethylstyrene are 152.62, the calculation is (β1+β2)/α=(61.0×0.9687/152.62)/(33.3/166.22)=1.93. In addition, β1/β2=95/5=19. The HP-LC chart of the obtained compound (A3) is shown in FIG. 3.

### Example 4

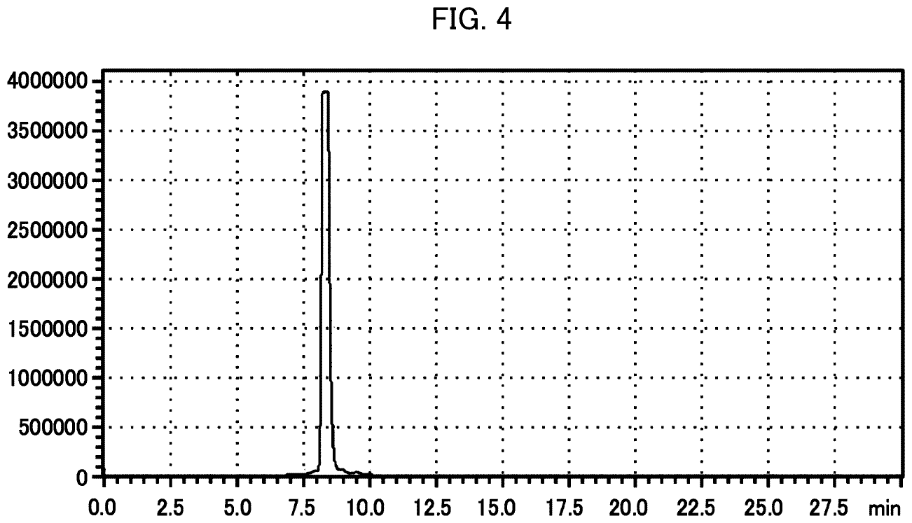

While purging with nitrogen into a flask equipped with a thermometer, a condenser, and a stirrer, 200 parts of DMSO, 33.3 parts of fluorene, and 24 parts of sodium hydroxide were added and stirred at 35° C. for 30 minutes. Then, while keeping the internal temperature at 40° C. or less, a mixture of 30.5 parts of CMS-14 (manufactured by AGC Seimi Chemical Co., Ltd., a mixture of 4-chloromethylstyrene and 3-chloromethylstyrene, 4-chloromethylstyrene content: 3-chloromethylstyrene content=95:5, purity 96.87%) and 30.5 parts of CMS-P (manufactured by AGC Seimi Chemical Co., Ltd., a mixture of 4-chloromethylstyrene and 3-chloromethylstyrene, 4-chloromethylstyrene content: 3-chloromethylstyrene content=1:1, purity 95.59%) was added dropwise over 1 hour, and the mixture was reacted at 40° C. for 6 hours. 200 parts of methanol and 100 parts of water were added to crystallize, and the crystals were collected by filtration. The collected crystals were dissolved in 150 parts of toluene, and the organic layer was washed four times with 100 parts of water. The obtained organic layer was concentrated to obtain 76.7 parts of compound (A4). When the molecular weight of fluorene is 166.22, and the molecular weights of 4-chloromethylstyrene and 3-chloromethylstyrene are 152.62, the calculation is (β1+β2)/α={(30.5×0.9687+30.5×0.9559)/152.62}/(33.3/166.22)=1.92. In addition, β1/β2=(30.5×0.95×0.9687+30.5×0.50×0.9559)/(30.5×0.05×0.9687+30.5×0.50×0.9559)=2. 7. The HP-LC chart of the obtained compound (A4) is shown in FIG. 4.

### Example 5

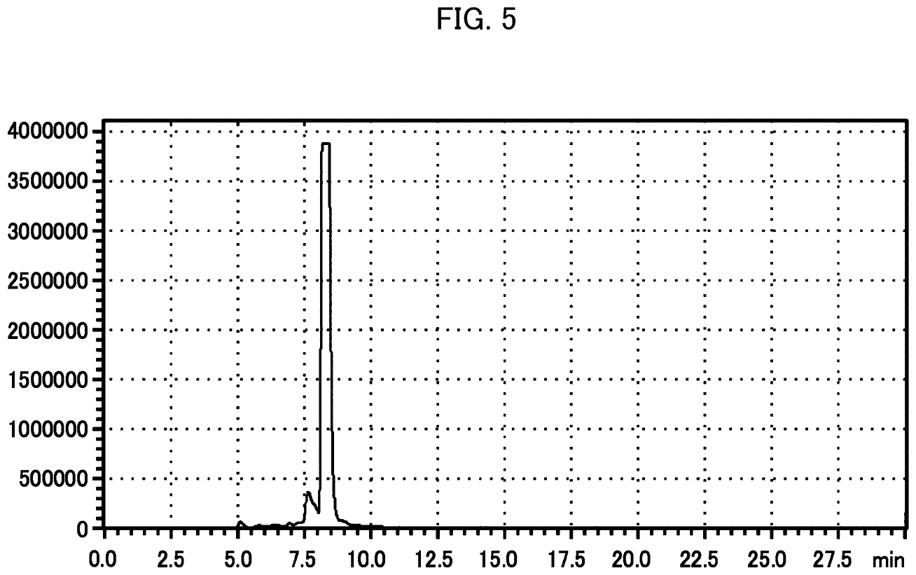

100 parts of DMSO, 33.3 parts of fluorene, and 24 parts of sodium hydroxide were added to a flask equipped with a thermometer, a condenser, and a stirrer while purging with nitrogen, and the mixture was stirred at 25° C. for 30 minutes. Then, while keeping the internal temperature at 30° C. or less, 64.1 parts of CMS-14 (manufactured by AGC Seimi Chemical Co., Ltd., a mixture of 4-chloromethylstyrene and 3-chloromethylstyrene, 4-chloromethylstyrene content: 3-chloromethylstyrene content=95:5, purity 96.87%) was added dropwise over 2 hours, and the mixture was reacted at 25° C. for 2 hours and at 40° C. for 2 hours. 150 parts of toluene was added, and the organic layer was washed four times with 100 parts of water. The obtained organic layer was concentrated to obtain 80.1 parts of compound (A5). When the molecular weight of fluorene is 166.22, and the molecular weights of 4-chloromethylstyrene and 3-chloromethylstyrene are 152.62, the calculation is (β1+β2)/α=(64.1×0.9687/152.62)/(33.3/166.22)=2.03. In addition, β1/β2=95/5=19. The HP-LC chart of the obtained compound (A5) is shown in FIG. 5.

### Comparative Synthesis Example 1

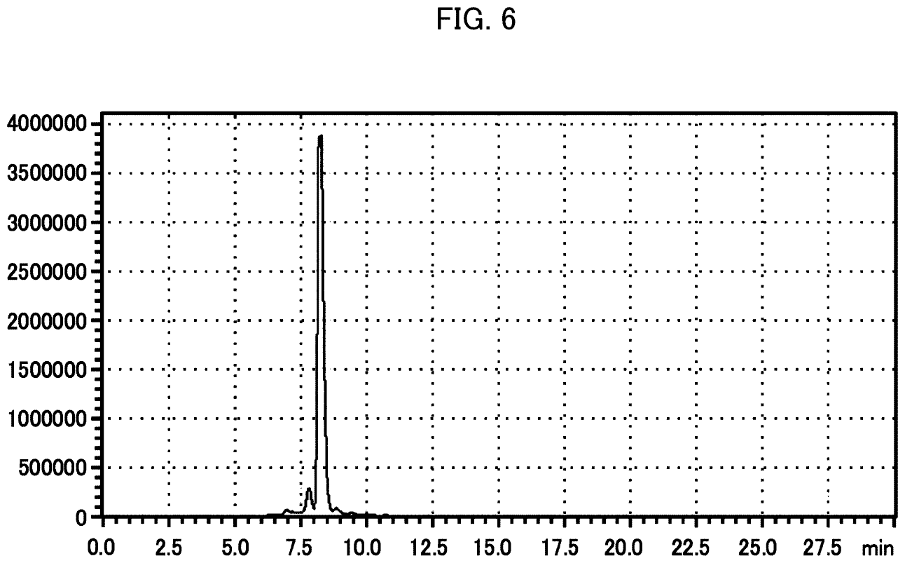

While purging nitrogen into a flask equipped with a thermometer, a cooling tube, and a stirrer, 200 parts of DMSO, 33.3 parts of fluorene, and 24 parts of sodium hydroxide were added and stirred at 35° C. for 30 minutes. Then, while keeping the internal temperature at 40° C. or less, 54.9 parts of CMS-14 (manufactured by AGC Seimi Chemical Co., Ltd., a mixture of 4-chloromethylstyrene and 3-chloromethylstyrene, 4-chloromethylstyrene: 3-chloromethylstyrene=95:5 (mol ratio), purity 96.87 wt %) was dropped over 1 hour, and the reaction was carried out at 40° C. for 12 hours. 200 parts of methanol and 100 parts of water were added to crystallize, and the crystals were collected by filtration. The collected crystals were dissolved in 200 parts of toluene, and the organic layer was washed four times with 100 parts of water. The obtained organic layer was concentrated to obtain 59.0 parts of compound (A6). When the molecular weight of fluorene is 166.22, and the molecular weights of 4-chloromethylstyrene and 3-chloromethylstyrene are 152.62, the calculation is (β1+β2)/α=(54.9×0.9687/152.62)/(33.3/166.22)=1.74. In addition, β1/β2=95/5=19. The HP-LC chart of the obtained compound (A6) is shown in FIG. 6.

### Comparative Synthesis Example 2

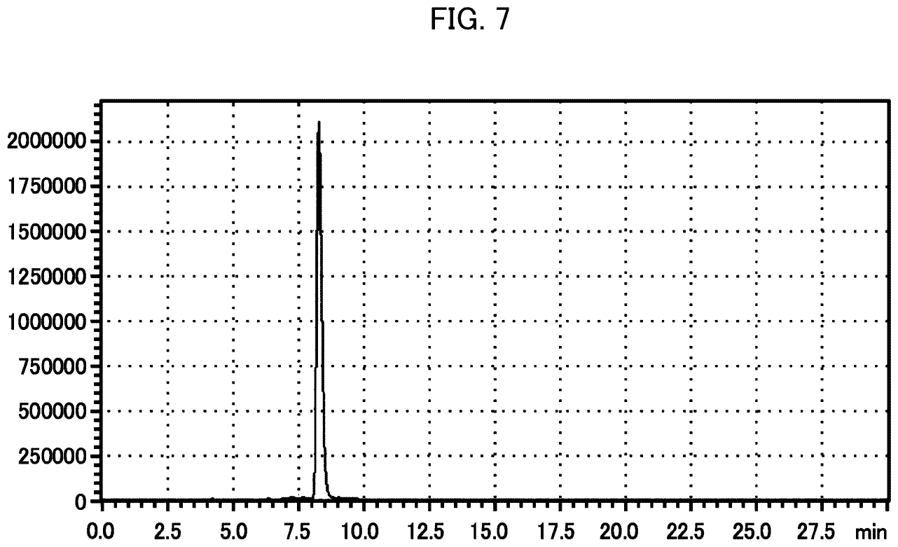

While purging with nitrogen into a flask equipped with a thermometer, a cooling tube, and a stirrer, 133 parts of methyl isobutyl ketone (hereinafter also referred to as MIBK), 33.3 parts of fluorene, 1.9 parts of tetrabutylammonium bromide, 0.49 parts of hydroquinone, and 64 parts of 50 wt % aqueous sodium hydroxide solution were added, and the internal temperature was raised to 60° C. Then, 71.2 parts of CMS-P (manufactured by AGC Seimi Chemical Co., Ltd., a mixture of 4-chloromethylstyrene and 3-chloromethylstyrene, 4-chloromethylstyrene: 3-chloromethylstyrene=1:1 (mol ratio), purity 95.59 wt %) was dropped over 1 hour and reacted at 60° C. for 9 hours. Neutralized with 41.6 parts of 35 wt % aqueous hydrochloric acid solution, and the organic layer was washed three times with 100 parts of water. Recrystallized with toluene and methanol to obtain 35.6 parts of compound (A7). When the molecular weight of fluorene is 166.22, and the molecular weights of 4-chloromethylstyrene and 3-chloromethylstyrene are 152.62, the calculation is (β1+β2)/α=(71.2×0.9559/152.62)/(33.3/166.22)=2.23. In addition, β1/β2=1/1=1. The HP-LC chart of the obtained compound (A7) is shown in FIG. 7.

### Examples 6 to 10, Comparative Examples 1 to 3

The compounds (A1 to A7) obtained in Examples 1 to 5, Comparative Synthesis Examples 1 and 2, and OPE-2St (polyphenylene ether compound, manufactured by Mitsubishi Gas Chemical Co., Ltd.) were used in the amounts shown in Table 1, and were sandwiched between mirror-finished copper foils (T4X: manufactured by Fukuda Metal Copper Foil Co., Ltd.) and vacuum-press molded, followed by curing at 220° C. for 2 hours. At this time, a 250 μm-thick cushion paper with a 150 mm×150 mm hole cut out from the center was used as a spacer. For the evaluation, a test piece was cut out to the desired size using a laser cutter as necessary, and the evaluation was performed.

### <Permittivity Test/Dissipation Factor Test>

Using a 10 GHz cavity resonator manufactured by ATE Corporation, tests were performed by a cavity resonator perturbation method at 25° C. The test was performed on a sample with a width of 1.7 mm, a length of 100 mm, and a thickness of 0.3 mm. The evaluation results are shown in Table 1.

### <Copper Foil Corrosion Test>

After vacuum pressing in the preparation of the cured product, the product was cured at 220° C. for 2 hours and then returned to room temperature. If corrosion was observed on the copper foil part not in contact with the resin by visual inspection, it was marked with “X”, and if no corrosion was observed on the copper foil part not in contact with the resin, it was marked with “O”. The evaluation results are shown in Table 1.

<Heat resistance (DSC)>
Differential scanning calorimeter: DSC6220 (manufactured by SII NanoTechnology Inc.)
Measurement temperature range: 30 to 350° C.
Heating rate: 10° C./min.
Atmosphere: Nitrogen (30 mL/min).
Sample amount: 5 mg.
Tg: The inflection point on the DSC chart was taken as Tg. If there was no clear inflection point, it was determined that the Tg was 350° C. or higher.

TABLE 1

| | | Example | Example | Example | Example | Example | Comparative | Comparative | Comparative |
|---|---|---|---|---|---|---|---|---|---|
| | | 6 | 7 | 8 | 9 | 10 | Example 1 | Example 2 | Example 3 |
| Compound | A1 | 100 | | | | | | | |
| | A2 | | 100 | | | | | | |
| | A3 | | | 100 | | | | | |
| | A4 | | | | 100 | | | | |
| | A5 | | | | | 100 | | | |
| | A6 | | | | | | 100 | | |
| | A7 | | | | | | | 100 | |
| | OPE-2St | | | | | | | | 100 |

| | | | | | | | | |
|---|---|---|---|---|---|---|---|---|
| (β1 + β2)/α | 1.84 | 1.81 | 1.93 | 1.92 | 2.03 | 1.74 | 2.23 | — |
| β1/β2 | 19 | 1 | 19 | 2.7 | 19 | 19 | 1 | — |

Evaluation Results

| | | | | | | | | | |
|---|---|---|---|---|---|---|---|---|---|
| Dielectric | Permittivity | 2.48 | 2.53 | 2.58 | 2.59 | 2.48 | 2.59 | 2.51 | 2.51 |
| properties | Dissipation | 0.00075 | 0.00089 | 0.00049 | 0.00098 | 0.00082 | 0.00217 | 0.00410 | 0.00395 |
| | factor | | | | | | | | |

| | | | | | | | | |
|---|---|---|---|---|---|---|---|---|
| Copper foil corrosion | ∘ | ∘ | ∘ | ∘ | ∘ | ∘ | x | ∘ |
| Tg | 350° C. | 350° C. | 350° C. | 350° C. | 350° C. | 350° C. | 350° C. | 240° C. |
| | or more | or more | or more | or more | or more | or more | or more | |

From the results in Table 1, when (β1+β2)/α is 2.1 or less, the copper foil is not corroded. In addition, when (β1+β2)/α is 1.8 or more and 2.1 or less, it was confirmed that the compound has low dielectric properties with a dielectric dissipation factor of 0.0016 or less. In addition, compared with OPE-2St (Comparative Example 3), which has been used as a standard styrene-based material in the past, it was confirmed that the compound of the present invention has low dielectric properties and excellent heat resistance with a Tg of 350° C. or more.

### <Analysis of Chlorine Content by X-Ray Fluorescence Analysis>

Apparatus: Energy dispersive X-ray fluorescence analyzer (EDX-720, manufactured by Shimadzu Corporation)
Procedure: 1.0 part of the compounds (A1, A3) obtained in Examples 1 and 3 was placed on a 6 μm thick polyester film (Mylar (registered trademark), manufactured by Rigaku Corporation), 1.0 part of toluene was added, dissolved and homogenized, and the amount of chlorine was quantified. The amount of chlorine was calculated based on the obtained measured value and converted to 100% solids. The evaluation results are shown in Table 2.

TABLE 2

| | Example 11 | Example 12 |
|---|---|---|
| | Compound A1 | Compound A3 |
| Chhlorine content (ppm) | 1000 | 460 |

### INDUSTRIAL APPLICABILITY

The compound of the present invention is suitably used for electric and electronic parts such as semiconductor encapsulants, printed wiring boards, and build-up laminates.

This application claims priority based on Japanese Patent Application No. 2022-187893, filed on Nov. 25, 2022.

1. A compound obtained by reacting a compound represented by the following formula (1) with a compound represented by the following formula (2-1) and/or a compound represented by the following formula (2-2), wherein,
(β1+β2)/α is 1.8 or more and 2.1 or less, wherein
α is the number of moles of the compound represented by the formula (1),
β1 is the number of moles of the compound represented by the formula (2-1), and
β2 is the number of moles of the compound represented by the formula (2-2): 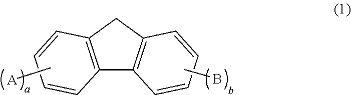
(in the above formula (1), A and B each represent a hydrogen atom or a hydrocarbon group having 1 to 5 carbon atoms, and a and b each represent an integer of 1 to 4, 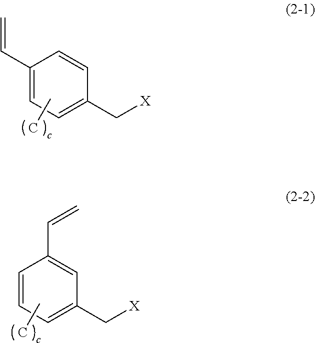
(in the above formula (2-1), C represents a hydrogen atom or a hydrocarbon group having 1 to 5 carbon atoms, X represents a halogen element, and c represents an integer of 1 to 4,
in the above formula (2-2), C represents a hydrogen atom or a hydrocarbon group having 1 to 5 carbon atoms, X represents a halogen element, and c represents an integer of 1 to 4.

2. The compound according to claim 1, wherein (β1+β2)/α is 1.8 or more and 1.95 or less.

3. The compound according to claim 1 for use in a printed wiring board.

4. The compound according to claim 1, having a dielectric dissipation factor of 0.0016 or less at a frequency of 10 GHz measured at 25° C.

5. The compound according to claim 1, wherein β1/β2 is 0.5 to 25.

6. The compound according to claim 1, wherein β1/β2 is 0.8 to 3.0.

7. A curable resin composition comprising the compound according to claim 1.

8. A cured product obtained by curing the compound according to claim 1.

9. A method for producing a compound represented by the following formula (3), comprising reacting a compound represented by the following formula (1) with a compound represented by the following formula (2-1) and/or a compound represented by the following formula (2-2) in the presence of a basic catalyst in an aprotic polar solvent: 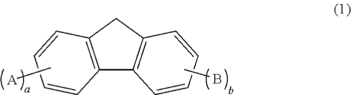
(in the above formula (1), A and B each represent a hydrogen atom or a hydrocarbon group having 1 to 5 carbon atoms, and a and b each represent an integer of 1 to 4; 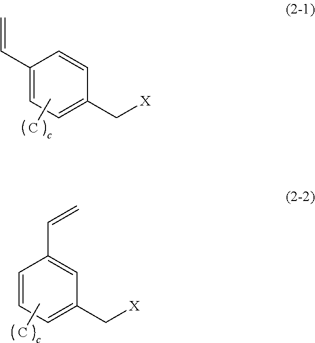
(in the above formula (2-1), C represents a hydrogen atom or a hydrocarbon group having 1 to 5 carbon atoms, X represents a halogen element, and c represents an integer of 1 to 4,
in the above formula (2-2), C represents a hydrogen atom or a hydrocarbon group having 1 to 5 carbon atoms, X represents a halogen element, and c represents an integer of 1 to 4; 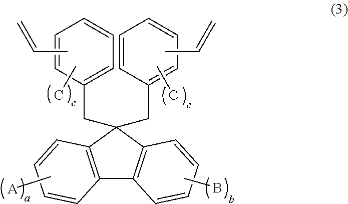
(in the above formula (3),
A, B, a, and b represent A, B, a, and b in the above formula (1), and
C and c represent C and c in the above formula (2-1) or (2-2).
